(19) United States
(12) Patent Application Publication
(10) Pub. No.: US 2025/0264818 A1
(43) Pub. Date: Aug. 21, 2025

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Tomoya Sasaki, Kanagawa (JP); Ryosuke Fujii, Kanagawa (JP); Yuto Okazaki, Kanagawa (JP); Makoto Yabe, Kanagawa (JP); Kosuke Narita, Kanagawa (JP)

(73) Assignee: FUJIFILM Business Innovation Corp., Tokyo (JP)

(21) Appl. No.: 18/789,803

(22) Filed: Jul. 31, 2024

(30) Foreign Application Priority Data
Feb. 16, 2024 (JP) 2024-022435

(51) Int. Cl. G03G 5/05

(52) U.S. Cl. CPC G03G 5/056

(57) ABSTRACT

An electrophotographic photoreceptor includes: a conductive substrate; and a multilayer-type photosensitive layer that is disposed on the conductive substrate and has a charge generation layer and a charge transport layer. The charge transport layer contains a charge-transporting material and a polyester resin (1) having a dicarboxylic acid unit (A) represented by formula (A) and a diol unit (B) represented by formula (B). The polyester resin (1) contained in the charge transport layer has a molecular weight distribution curve with at least two peaks and satisfies 50,000≤Mw≤200,000, and 0.4≤(Mmax−Mmin)/Mw≤5.0, wherein Mmin is a molecular weight at a top of a peak corresponding to a lowest molecular weight, Mmax is a molecular weight at a top of a peak corresponding to a highest molecular weight, and Mw is a weight average molecular weight of the polyester resin (1) contained in the charge transport layer.

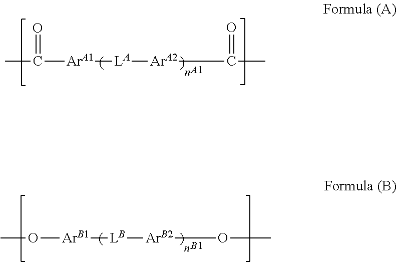

In formula (A), Ar^{A1} and Ar^{A2} are each independently an optionally substituted aromatic ring, L^{A} is a single bond or a divalent linking group, and n^{A1} is 0, 1, or 2. In formula (B), Ar^{B1} and Ar^{B2} are each independently an optionally substituted aromatic ring, LB is a single bond, an oxygen atom, a sulfur atom, or —C(Rb¹) (Rb²)—, and n^{B1} is 0, 1, or 2; and Rb¹ and Rb² are each independently a hydrogen atom, a C1-C20 alkyl group, a C6-C12 aryl group, or a C7-C20 aralkyl group, and Rb¹ and Rb² taken together may form a cyclic alkyl group.

### CROSS-REFERENCE TO RELATED APPLICATIONS

This application is based on and claims priority under 35 USC 119 from Japanese Patent Application No. 2024-022435 filed Feb. 16, 2024.

### BACKGROUND

### (i) Technical Field

The present disclosure relates to an electrophotographic photoreceptor, a process cartridge, and an image forming apparatus.

### (ii) Related Art

Japanese Unexamined Patent Application Publication No. 2023-047285 discloses an electrophotographic photoreceptor including a conductive substrate and a multilayer-type photosensitive layer that has a charge generation layer and a charge transport layer, wherein the charge transport layer contains a charge-transporting material and a polyester resin (1) having a dicarboxylic acid unit (A) represented by predetermined formula (A) and a diol unit (B) represented by predetermined formula (B), and the charge transport layer satisfies 5≤A≤40, 0.28≤Cs≤0.55, 27≤Ds≤50, and 2.5≤(A×Ds)/(Cs×100)≤70.0, wherein A (×10⁴) is the weight average molecular weight Mw of the polyester resin (1) contained in the charge transport layer, Cs is the ratio M1/M2 of the mass M1 of the charge-transporting material contained in the charge transport layer to the mass M2 of the charge transport layer, and Ds (μm) is the average thickness of the charge transport layer.

Japanese Unexamined Patent Application Publication No. 2023-130296 discloses an electrophotographic photoreceptor including a conductive substrate, a undercoat layer disposed on the conductive substrate, and a multilayer-type photosensitive layer that is disposed on the undercoat layer and that has a charge generation layer and a charge transport layer, wherein the charge transport layer contains a charge-transporting material and a polyester resin, and the electrophotographic photoreceptor satisfies 27≤As≤50, 10≤Bs≤40, and 0.70≤As/Bs≤4.80, wherein As (μm) is the average thickness of the charge transport layer, and Bs (μm) is the average thickness of the undercoat layer.

### SUMMARY

Aspects of non-limiting embodiments of the present disclosure relate to an electrophotographic photoreceptor that has uniform potential distribution on its surface, generates few image defects even if dropped in a high temperature-high humidity environment, and generates few image defects even if stored in a high temperature-high humidity environment for a long term.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above object include the following aspects. The formulas are the same as the formulas with the same corresponding numbers described below.

According to an aspect of the present disclosure, there is provided an electrophotographic photoreceptor including:
a conductive substrate; and
a multilayer-type photosensitive layer that is disposed on the conductive substrate and has a charge generation layer and a charge transport layer,
wherein the charge transport layer contains a charge-transporting material and a polyester resin (1) having a dicarboxylic acid unit (A) represented by formula (A) and a diol unit (B) represented by formula (B), and
the polyester resin (1) contained in the charge transport layer has a molecular weight distribution curve with at least two peaks and satisfies 50,000≤Mw≤200,000, and 0.4≤(Mmax−Mmin)/Mw≤5.0, wherein Mmin is a molecular weight at a top of a peak corresponding to a lowest molecular weight, Mmax is a molecular weight at a top of a peak corresponding to a highest molecular weight, and Mw is a weight average molecular weight of the polyester resin (1) contained in the charge transport layer:

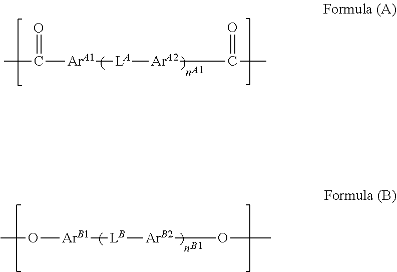

in formula (A), Ar^{A1} and Ar^{A2} are each independently an optionally substituted aromatic ring, L^{A} is a single bond or a divalent linking group, and n^{A1} is 0, 1, or 2; and
in formula (B), Ar^{B1} and Ar^{B2} are each independently an optionally substituted aromatic ring, LB is a single bond, an oxygen atom, a sulfur atom, or —C(Rb¹)(Rb²)—, and n^{B1} is 0, 1, or 2; and Rb¹ and Rb² are each independently a hydrogen atom, a C1-C20 alkyl group, a C6-C12 aryl group, or a C7-C20 aralkyl group, and Rb¹ and Rb² taken together may form a cyclic alkyl group.

### BRIEF DESCRIPTION OF THE DRAWINGS

Exemplary embodiments of the present disclosure will be described in detail based on the following figures, wherein:

FIG. 1 is a partial cross-sectional view of an example of the layer structure of an electrophotographic photoreceptor according to a first exemplary embodiment;

FIG. 2 is a partial cross-sectional view of an example of the layer structure of an electrophotographic photoreceptor according to a second exemplary embodiment;

FIG. 3 is a schematic structural view of one example of an image forming apparatus according to the present exemplary embodiment; and

FIG. 4 is a schematic structural view of another example of the image forming apparatus according to the present exemplary embodiment.

### DETAILED DESCRIPTION

Exemplary embodiments of the present disclosure will be described below. The following description and Examples are for illustrating the exemplary embodiments, and are not intended to limit the scope of the exemplary embodiments.

A numerical range expressed by using “to” in the present disclosure indicates a range including the values before and after “to” as the minimum value and the maximum value.

With regard to numerical ranges described stepwise in the present disclosure, the upper limit or the lower limit of one numerical range may be replaced by the upper limit or the lower limit of other numerical ranges described stepwise. The upper limit or lower limit of any numerical range described in the present disclosure may be replaced by a value described in Examples.

The phase “A and/or B” in the present disclosure has the same meaning as the phrase “at least one of A and B.” In other words, the phrase “A and/or B” means only A, only B, or a combination of A and B.

In the present disclosure, the term “step” includes not only an independent step but also a step that cannot be clearly distinguished from other steps but may accomplish the purpose of the step.

In the description of exemplary embodiments with reference to the drawings in the present disclosure, the configurations according to the exemplary embodiments are not limited to the configurations illustrated in the drawings. The sizes of members in each figure are schematic, and the relative relationship between the sizes of the members is not limited to what is illustrated.

In the present disclosure, each component may include two or more corresponding substances. In the present disclosure, the amount of each component in a composition refers to, when there are two or more substances corresponding to each component in the composition, the total amount of the substances present in the composition, unless otherwise specified.

In the present disclosure, each component may include two or more types of particles corresponding to each component. The particle size of each component refers to, when there are two or more types of particles corresponding to each component in the composition, the particle size of a mixture of two or more types of particles present in the composition, unless otherwise specified.

In the present disclosure, alkyl groups and alkylene groups include linear, branched, and cyclic groups, unless otherwise specified.

In the present disclosure, hydrogen atoms in organic groups, aromatic rings, linking groups, alkyl groups, alkylene groups, aryl groups, aralkyl groups, alkoxy groups, aryloxy groups, and other groups may be substituted by halogen atoms.

To express compounds by structural formulas in the present disclosure, compounds may be represented by structural formulas without symbols (C and H) representing carbon and hydrogen atoms in hydrocarbon groups and/or hydrocarbon chains.

In the present disclosure, the “structural unit” of a copolymer or resin has the same meaning as a monomer unit.

### Electrophotographic Photoreceptor

In the present disclosure, a first exemplary embodiment and a second exemplary embodiment are provided as electrophotographic photoreceptors (hereinafter also referred to as “photoreceptors”).

A photoreceptor according to the first exemplary embodiment includes: a conductive substrate; and a multilayer-type photosensitive layer that is disposed on the conductive substrate and has a charge generation layer and a charge transport layer.

The photoreceptor according to the first exemplary embodiment may further include other layers (e.g., undercoat layer, intermediate layer). In the photoreceptor according to the first exemplary embodiment, the charge transport layer may be a surface layer.

A photoreceptor according to the second exemplary embodiment includes: a conductive substrate; and a single layer type photosensitive layer disposed on the conductive substrate.

The photoreceptor according to the second exemplary embodiment may further include other layers (e.g., undercoat layer, intermediate layer). In the photoreceptor according to the second exemplary embodiment, the single layer type photosensitive layer may be a surface layer.

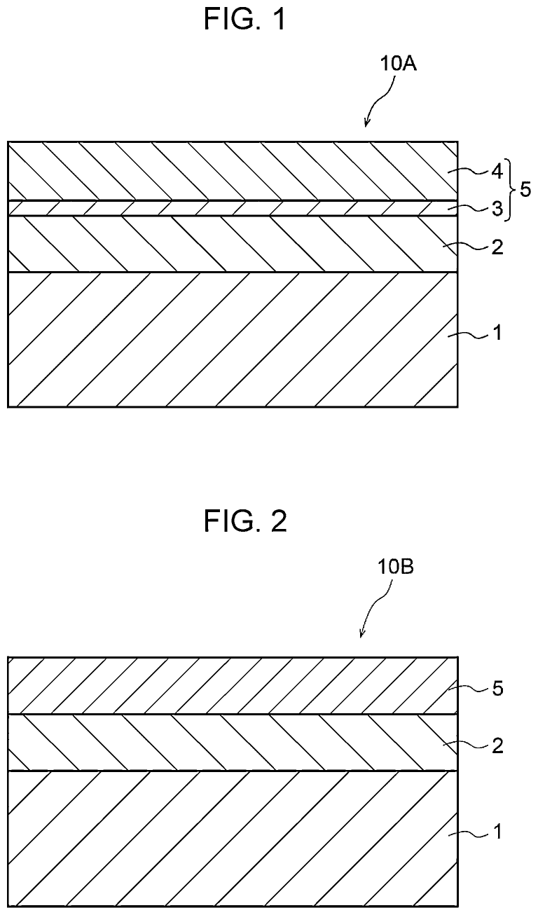

FIG. 1 is a partial cross-sectional view schematically illustrating an example of the layer structure of the photoreceptor according to the first exemplary embodiment. Referring to FIG. 1, a photoreceptor 10A has a multilayer-type photosensitive layer. The photoreceptor 10A includes an undercoat layer 2, a charge generation layer 3, and a charge transport layer 4 in this order on a conductive substrate 1. The charge generation layer 3 and the charge transport layer 4 constitute a photosensitive layer 5 (so-called layered photosensitive layer). The photoreceptor 10A may have an intermediate layer (not shown) between the undercoat layer 2 and the charge generation layer 3. The undercoat layer 2 is an optional layer.

FIG. 2 is a partial cross-sectional view schematically illustrating an example of the layer structure of the photoreceptor according to the second exemplary embodiment. Referring to FIG. 2, a photoreceptor 10B has a single layer type photosensitive layer. In the photoreceptor 10B, an undercoat layer 2 and a photosensitive layer 5 are stacked in this order on a conductive substrate 1. The photoreceptor 10B may have an intermediate layer (not shown) between the undercoat layer 2 and the photosensitive layer 5. The undercoat layer 2 is an optional layer.

In the photoreceptor according to the first exemplary embodiment, the charge transport layer in the multilayer-type photosensitive layer contains a charge-transporting material and a polyester resin (1), and the polyester resin (1) contained in the charge transport layer has a molecular weight distribution curve with at least two peaks and satisfies 50,000≤Mw≤200,000, and 0.4≤(Mmax−Mmin)/Mw≤5.0, wherein Mmin is the molecular weight at the top of a peak corresponding to the lowest molecular weight, Mmax is the molecular weight at the top of a peak corresponding to the highest molecular weight, and Mw is the weight average molecular weight of the polyester resin (1) contained in the charge transport layer.

In the photoreceptor according to the second exemplary embodiment, the single layer type photosensitive layer contains a charge-transporting material and a polyester resin (1), and the polyester resin (1) contained in the single layer type photosensitive layer has a molecular weight distribution curve with at least two peaks and satisfies 50,000≤Mw≤200,000, and 0.4≤(Mmax−Mmin)/Mw≤5.0, wherein Mmin is the molecular weight at the top of a peak corresponding to the lowest molecular weight, Mmax is the molecular weight at the top of a peak corresponding to the highest molecular weight, and Mw is the weight average molecular weight of the polyester resin (1) contained in the single layer type photosensitive layer.

In the description of matters common to the first exemplary embodiment and the second exemplary embodiment, both exemplary embodiments are collectively referred to below as the present exemplary embodiment. In the description of matters common to the charge transport layer and the single layer type photosensitive layer, both layers are collectively referred to as the photosensitive layer.

In the photoreceptor according to the present exemplary embodiment, the photosensitive layer contains the polyester resin (1).

In the photoreceptor according to the present exemplary embodiment, the polyester resin (1) contained in the photosensitive layer has a molecular weight distribution curve with at least two peaks and satisfies 50,000≤Mw≤200,000, and 0.4≤(Mmax−Mmin)/Mw≤5.0, wherein Mmin is the molecular weight at the top of a peak corresponding to the lowest molecular weight, Mmax is the molecular weight at the top of a peak corresponding to the highest molecular weight, and Mw is the weight average molecular weight of the polyester resin (1) contained in the photosensitive layer.

The polyester resin (1) contained in the photosensitive layer has a molecular weight distribution curve with at least two peaks. The polyester resin (1) having a molecular weight distribution curve with only one peak is less likely to ensure both “uniformity in potential distribution” and “image quality after dropping and storage in a high temperature-high humidity environment.”

If the polyester resin (1) contained in the photosensitive layer has a Mw of less than 50,000, the film easily softens and flows at high temperatures, and the image quality degrades after dropping and storage in a high temperature-high humidity environment. To prevent or reduce this phenomenon, the Mw of the polyester resin (1) contained in the photosensitive layer is 50,000 or more, preferably 80,000 or more, more preferably 90,000 or more.

If the polyester resin (1) contained in the photosensitive layer has a Mw of more than 200,000, the charge-transporting material has low dispersibility, and the potential distribution is less uniform. To prevent or reduce this phenomenon, the Mw of the polyester resin (1) contained in the photosensitive layer is 200,000 or less, preferably 150,000 or less, more preferably 130,000 or less.

If the polyester resin (1) contained in the photosensitive layer has (Mmax-Mmin)/Mw of less than 0.4, a low-molecular-weight component and a high-molecular-weight component are less likely to have respective favorable functions, and it is difficult to ensure both “uniformity in potential distribution” and “image quality after dropping and storage in a high temperature-high humidity environment.” To ensure both “uniformity in potential distribution” and “image quality after dropping and storage in a high temperature-high humidity environment”, the polyester resin (1) contained in the photosensitive layer has (Mmax−Mmin)/Mw of 0.4 or more, preferably 0.5 or more, more preferably 0.6 or more.

If the polyester resin (1) contained in the photosensitive layer has (Mmax-Mmin)/Mw of more than 5.0, the disadvantages of the low-molecular-weight component and the high-molecular-weight component (low-molecular-weight component: easily softens and flows, high-molecular-weight component: low dispersibility of charge-transporting material) become more obvious, and it is difficult to ensure both “uniformity in potential distribution” and “image quality after dropping and storage in a high temperature-high humidity environment.” To ensure both “uniformity in potential distribution” and “image quality after dropping and storage in a high temperature-high humidity environment”, the polyester resin (1) contained in the photosensitive layer has (Mmax−Mmin)/Mw of 5.0 or less, preferably 4.5 or less, more preferably 4.0 or less.

In the present exemplary embodiment, the molecular weight distribution curve, Mmin, Mmax, and the weight average molecular weight Mw of the polyester resin (1) contained in the photosensitive layer (the charge transport layer in the multilayer-type photosensitive layer in the first exemplary embodiment, or the single layer type photosensitive layer in the second exemplary embodiment) are determined as described below.

The photoreceptor is dipped in various solvents (or mixed solvents) to understand solvents that dissolve the photosensitive layer. The photoreceptor is dipped in a solvent that dissolves the photosensitive layer, so that the materials of the photosensitive layer are extracted in the solvent. The solvent in which the materials of the photosensitive layer have been extracted is added dropwise to a poor solvent (e.g., a non-polar solvent, such as hexane or toluene, a lower alcohol, such as methanol or isopropanol. The poor solvent may be a mixed solvent.) for the polyester resin (1) to reprecipitate the resin. The reprecipitation process is repeated twice as needed, and the reprecipitate is vacuum-dried to obtain the polyester resin (1).

The molecular weight of the polyester resin (1) obtained by this process is determined by gel permeation chromatography (GPC). The GPC system is, for example, HLC-8120 (Tosoh Corporation), the column is, for example, TSKgel GMHHR-M+TSKgel GMHHR-M (7.8 mm I.D.×30 cm) (Tosoh Corporation), and the solvent is tetrahydrofuran. The molecular weight calibration is carried out by using a monodisperse polystyrene standard, and the molecular weight Mmin at the top of the peak corresponding to the lowest molecular weight, the molecular weight Mmax at the top of the peak corresponding to the highest molecular weight, and the weight average molecular weight Mw are determined.

The presence of at least two peaks in the molecular weight distribution curve of the polyester resin (1) contained in the photosensitive layer can be realized by mixing two or more polyester resins (1) having different weight average molecular weights and using the mixed polyester resins (1) to form the photosensitive layer. The two or more polyester resins (1) mixed may be the same or different in terms of the type of structural unit.

When the weight average molecular weights of a resin a, a resin b, a resin c, . . . , a resin n, which are polyester resins (1) mixed, are denoted by Mw(a), Mw(b), Mw(c), . . . . Mw(n), and the mass ratios of the resin a, the resin b, the resin c, . . . , the resin n are denoted by W(a), W(b), W(c), . . . , W(n), the weight average molecular weight Mw(Mix) of the mixed polyester resins (1) is Mw(Mix)=Σ(Mw(n)× W(n)).

Two or more polyester resins (1) having different weight average molecular weights are mixed such that Mw(Mix) satisfies the relationship of 50,000≤Mw(Mix)≤200,000.

In addition, two or more polyester resins (1) having different weight average molecular weights are mixed such that Mw(Mix) and ΔMw, which is a difference between the minimum value and the maximum value among Mw(a), Mw(b), Mw(c), . . . , Mw(n), satisfy the relationship of 0.4×Mw(Mix)≤ΔMw≤5.0×Mw(Mix).

In the above description, the two or more polyester resins (1) mixed may be the same or different in terms of the type of structural unit. To improve the dispersion uniformity of the charge-transporting material in the photosensitive layer, the two or more polyester resins (1) mixed may be the same in terms of the type of structural unit. In other words, the photosensitive layer may contain one type of polyester resin (1) in terms of the type of structural unit.

The polyester resin (1) contained in the photosensitive layer and each layer of the photoreceptor will be described below in detail.

### Polyester Resin (1)

The photosensitive layer contains, as a binder resin, a polyester resin (1) having at least a dicarboxylic acid unit (A) and a diol unit (B). The polyester resin (1) may include another dicarboxylic acid unit other than the dicarboxylic acid unit (A). The polyester resin (1) may include another diol unit other than the diol unit (B).

The dicarboxylic acid unit (A) is a structural unit represented by formula (A).

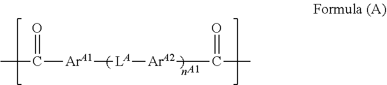

In formula (A), Ar^{A1} and Ar^{A2} are each independently an optionally substituted aromatic ring, L^{A} is a single bond or a divalent linking group, and n^{A1} is 0, 1, or 2.

The aromatic ring Ar^{A1} may be monocyclic or polycyclic. Examples of the aromatic ring include benzene, naphthalene, anthracene, and phenanthrene rings. The aromatic ring may be a benzene ring or a naphthalene ring.

The hydrogen atoms on the aromatic ring Ar^{A1} may be substituted by alkyl groups, aryl groups, aralkyl groups, alkoxy groups, aryloxy groups, and halogen atoms. The substituents by which the aromatic ring Ar^{A1} is substituted may be C1-C10 alkyl groups, C6-C12 aryl groups, and C1-C6 alkoxy groups.

The aromatic ring Ar^{A2} may be monocyclic or polycyclic. Examples of the aromatic ring include benzene, naphthalene, anthracene, and phenanthrene rings. The aromatic ring may be a benzene ring or a naphthalene ring.

The hydrogen atoms on the aromatic ring Ar^{A2} may be substituted by alkyl groups, aryl groups, aralkyl groups, alkoxy groups, aryloxy groups, and halogen atoms. The substituents by which the aromatic ring Ar^{A2} is substituted may be C1-C10 alkyl groups, C6-C12 aryl groups, and C1-C6 alkoxy groups.

When L^{A} is a divalent linking group, the divalent linking group is, for example, an oxygen atom, a sulfur atom, or —C(Ra¹)(Ra²)—. Ra¹ and Ra² are each independently a hydrogen atom, a C1-C10 alkyl group, a C6-C12 aryl group, or a C7-C20 aralkyl group, and Ra¹ and Ra² taken together may form a cyclic alkyl group.

The C1-C10 alkyl groups represented by Ra¹ and Ra² may be linear, branched, or cyclic. The number of carbon atoms in the alkyl groups is preferably 1 or more and 6 or less, more preferably 1 or more and 4 or less, still more preferably 1 or 2.

The C6-C12 aryl groups represented by Ra¹ and Ra² may be monocyclic or polycyclic. The number of carbon atoms in the aryl groups is preferably 6 or more and 10 or less, more preferably 6.

The alkyl group in the C7-C20 aralkyl groups represented by Ra¹ and Ra² may be linear, branched, or cyclic. The number of carbon atoms in the alkyl group in the C7-C20 aralkyl groups is preferably 1 or more and 4 or less, more preferably 1 or more and 3 or less, still more preferably 1 or 2.

The aryl group in the C7-C20 aralkyl groups represented by Ra¹ and Ra² may be monocyclic or polycyclic. The number of carbon atoms in the aryl group is preferably 6 or more and 10 or less, more preferably 6.

The dicarboxylic acid unit (A) may include at least one selected from the group consisting of a dicarboxylic acid unit (A1) represented by formula (A1), a dicarboxylic acid unit (A2) represented by formula (A2), a dicarboxylic acid unit (A3) represented by formula (A3), and a dicarboxylic acid unit (A4) represented by formula (A4). The dicarboxylic acid unit (A) preferably includes at least one selected from the group consisting of the dicarboxylic acid unit (A2), the dicarboxylic acid unit (A3), and the dicarboxylic acid unit (A4), more preferably includes the dicarboxylic acid unit (A2).

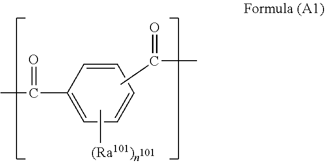

In formula (A1), n¹⁰¹ is an integer of 0 or more and 4 or less, n¹⁰¹ Ra¹⁰¹'s are each independently a C1-C10 alkyl group, a C6-C12 aryl group, or a C1-C6 alkoxy group.

n¹⁰¹ is preferably 0, 1, or 2, more preferably 0 or 1, still more preferably 0.

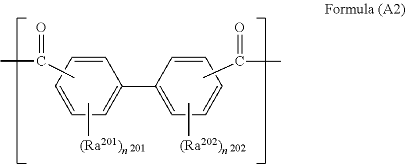

In formula (A2), n²⁰¹ and n²⁰² are each independently an integer of 0 or more and 4 or less, n²⁰¹ Ra²⁰¹'s and n²⁰² Ra²⁰²'s are each independently a C1-C10 alkyl group, a C6-C12 aryl group, or a C1-C6 alkoxy group.

n²⁰¹ is preferably 0, 1, or 2, more preferably 0 or 1, still more preferably 0.

n²⁰² is preferably 0, 1, or 2, more preferably 0 or 1, still more preferably 0.

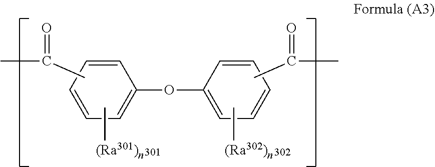

In formula (A3), n³⁰¹ and n³⁰² are each independently an integer of 0 or more and 4 or less, n³⁰¹ Ra³⁰¹'s and n³⁰² Ra³⁰²'s are each independently a C1-C10 alkyl group, a C6-C12 aryl group, or a C1-C6 alkoxy group.

n³⁰¹ is preferably 0, 1, or 2, more preferably 0 or 1, still more preferably 0.

n³⁰² is preferably 0, 1, or 2, more preferably 0 or 1, still more preferably 0.

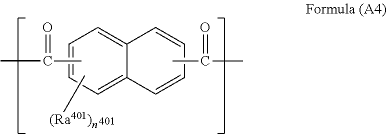

In formula (A4), n⁴⁰¹ is an integer of 0 or more and 6 or less, n⁴⁰¹ Ra⁴⁰¹'s are each independently a C1-C10 alkyl group, a C6-C12 aryl group, or a C1-C6 alkoxy group.

n⁴⁰¹ is preferably an integer of 0 or more and 4 or less, more preferably 0, 1, or 2, still more preferably 0.

Since Ra¹⁰¹ in formula (A1), Ra²⁰¹ and Ra²⁰² in formula (A2), Ra³⁰¹ and Ra³⁰² in formula (A3), and Ra⁴⁰¹ in formula (A4) have the same specific forms and the same suitable forms, Ra¹⁰¹, Ra²⁰¹, Ra²⁰², Ra³⁰¹, Ra³⁰², and Ra⁴⁰¹ are collectively referred to as “Ra” in the following description.

The C1-C10 alkyl group represented by Ra may be linear, branched, or cyclic. The number of carbon atoms in the alkyl group is preferably 1 or more and 6 or less, more preferably 1 or more and 4 or less, still more preferably 1 or 2.

Examples of the C1-C10 linear alkyl group include methyl, ethyl, n-propyl, n-butyl, n-pentyl, n-hexyl, n-heptyl, n-octyl, n-nonyl, and n-decyl groups.

Examples of the C3-C10 branched alkyl group include isopropyl, isobutyl, sec-butyl, tert-butyl, isopentyl, neopentyl, tert-pentyl, isohexyl, sec-hexyl, tert-hexyl, isoheptyl, sec-heptyl, tert-heptyl, isooctyl, sec-octyl, tert-octyl, isononyl, sec-nonyl, tert-nonyl, isodecyl, sec-decyl, and tert-decyl groups.

Examples of the C3-C10 cyclic alkyl group include cyclopropyl, cyclobutyl, cyclopentyl, cyclohexyl, cycloheptyl, cyclooctyl, cyclononyl, and cyclodecyl groups, and polycyclic (e.g., bicyclic, tricyclic, spirocyclic) alkyl groups where these monocyclic alkyl groups are linked to each other.

The C6-C12 aryl group represented by Ra may be monocyclic or polycyclic. The number of carbon atoms in the aryl group is preferably 6 or more and 10 or less, more preferably 6.

Examples of the C6-C12 aryl group include phenyl, biphenyl, 1-naphthyl, and 2-naphthyl groups.

The alkyl group in the C1-C6 alkoxy group represented by Ra may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C6 linear alkoxy group include methoxy, ethoxy, n-propoxy, n-butoxy, n-pentyloxy, and n-hexyloxy groups.

Examples of the C3-C6 branched alkoxy group include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group include cyclopropoxy, cyclobutoxy, cyclopentyloxy, and cyclohexyloxy groups.

Dicarboxylic acid units (A1-1) to (A1-9) are shown below as specific examples of the dicarboxylic acid unit (A1). The dicarboxylic acid unit (A1) is not limited to these.

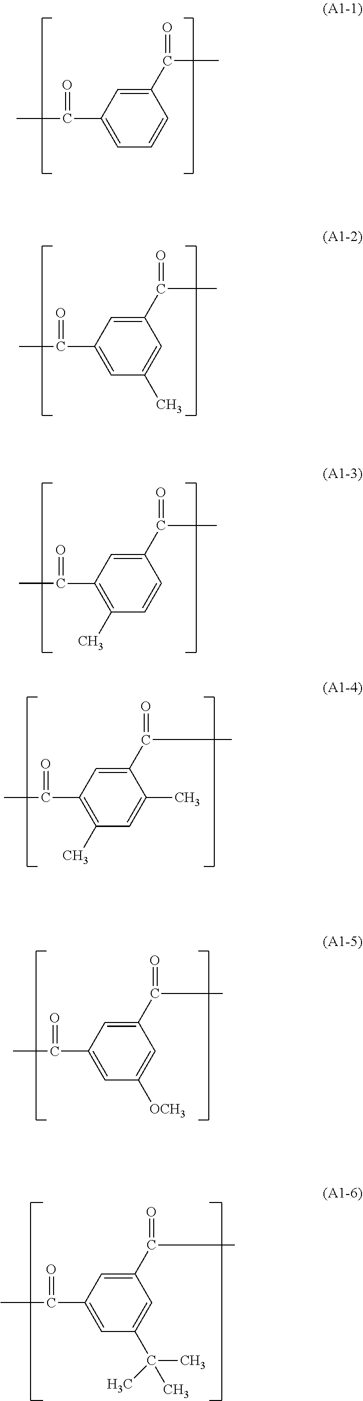

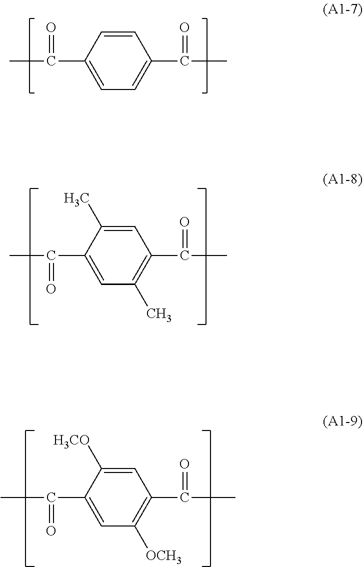

Dicarboxylic acid units (A2-1) to (A2-3) are shown below as specific examples of the dicarboxylic acid unit (A2). The dicarboxylic acid unit (A2) is not limited to these.

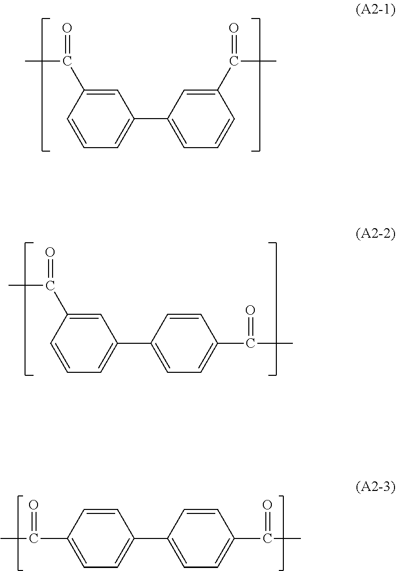

Dicarboxylic acid units (A3-1) to (A3-2) are shown below as specific examples of the dicarboxylic acid unit (A3). The dicarboxylic acid unit (A3) is not limited to these.

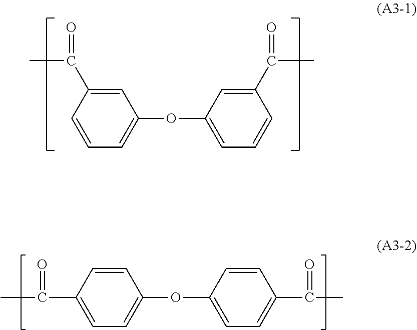

Dicarboxylic acid units (A4-1) to (A4-3) are shown below as specific examples of the dicarboxylic acid unit (A4). The dicarboxylic acid unit (A4) is not limited to these.

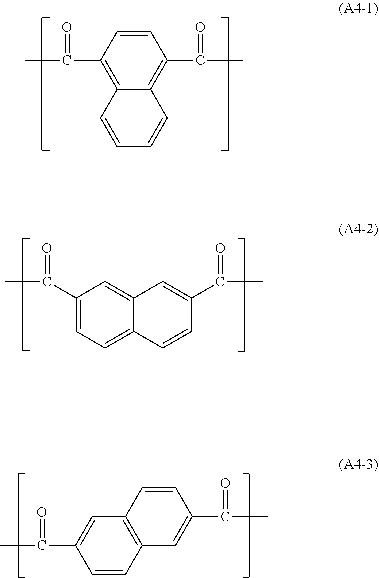

The dicarboxylic acid unit (A) preferably includes at least one selected from the group consisting of the dicarboxylic acid units (A1-1), (A1-7), (A2-3), (A3-2), and (A4-3) in the specific examples, more preferably includes at least one selected from the group consisting of the dicarboxylic acid units (A2-3), (A3-2), and (A4-3), more preferably includes at least the dicarboxylic acid unit (A2-3).

The total mass ratio of the dicarboxylic acid units (A1) to (A4) in the polyester resin (1) is preferably 15 mass % or more and 60 mass % or less.

When the total mass ratio of the dicarboxylic acid units (A1) to (A4) is 15 mass % or more, the photosensitive layer has high wear resistance. From this viewpoint, the total mass ratio of the dicarboxylic acid units (A1) to (A4) is more preferably 20 mass % or more, still more preferably 25 mass % or more.

When the total mass ratio of the dicarboxylic acid units (A1) to (A4) is 60 mass % or less, the photosensitive layer is less likely to peel off. From this viewpoint, the total mass ratio of the dicarboxylic acid units (A1) to (A4) is more preferably 55 mass % or less, still more preferably 50 mass % or less.

The polyester resin (1) may include one or two or more of the dicarboxylic acid units (A1) to (A4).

Examples of another dicarboxylic acid unit (A) other than the dicarboxylic acid units (A1) to (A4) include aliphatic dicarboxylic acid (e.g., oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (e.g., cyclohexanedicarboxylic acid) units, and lower (e.g., C1-C5) alkyl ester units thereof. The polyester resin (1) may include one or two or more of these dicarboxylic acid units.

The polyester resin (1) may include one type or two or more types of dicarboxylic acid units (A).

The diol unit (B) is a structural unit represented by formula (B).

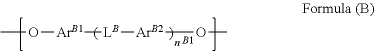

In formula (B), Ar^{B1} and Ar^{B2} are each independently an optionally substituted aromatic ring, LB is a single bond, an oxygen atom, a sulfur atom, or —C(Rb¹)(Rb²)—, and n^{B1} is 0, 1, or 2. Rb¹ and Rb² are each independently a hydrogen atom, a C1-C20 alkyl group, a C6-C12 aryl group, or a C7-C20 aralkyl group, and Rb¹ and Rb² taken together may form a cyclic alkyl group.

The aromatic ring Ar^{B1} may be monocyclic or polycyclic. Examples of the aromatic ring include benzene, naphthalene, anthracene, and phenanthrene rings. The aromatic ring may be a benzene ring or a naphthalene ring.

The hydrogen atoms on the aromatic ring Ar^{B1} may be substituted by alkyl groups, aryl groups, aralkyl groups, alkoxy groups, aryloxy groups, and halogen atoms. The substituents by which the aromatic ring Ar^{B1} is substituted may be C1-C10 alkyl groups, C6-C12 aryl groups, and C1-C6 alkoxy groups.

The aromatic ring Ar^{B2} may be monocyclic or polycyclic. Examples of the aromatic ring include benzene, naphthalene, anthracene, and phenanthrene rings. The aromatic ring may be a benzene ring or a naphthalene ring.

The hydrogen atoms on the aromatic ring Ar^{B2} may be substituted by alkyl groups, aryl groups, aralkyl groups, alkoxy groups, aryloxy groups, and halogen atoms. The substituents by which the aromatic ring Ar^{B2} is substituted may be C1-C10 alkyl groups, C6-C12 aryl groups, and C1-C6 alkoxy groups.

The C1-C20 alkyl groups represented by Rb¹ and Rb² may be linear, branched, or cyclic. The number of carbon atoms in the alkyl groups is preferably 1 or more and 18 or less, more preferably 1 or more and 14 or less, still more preferably 1 or more and 10 or less.

The C6-C12 aryl groups represented by Rb¹ and Rb² may be monocyclic or polycyclic. The number of carbon atoms in the aryl groups is preferably 6 or more and 10 or less, more preferably 6.

The alkyl group in the C7-C20 aralkyl groups represented by Rb¹ and Rb² may be linear, branched, or cyclic. The number of carbon atoms in the alkyl group in the C7-C20 aralkyl groups is preferably 1 or more and 4 or less, more preferably 1 or more and 3 or less, still more preferably 1 or 2.

The aryl group in the C7-C20 aralkyl groups represented by Rb¹ and Rb² may be monocyclic or polycyclic. The number of carbon atoms in the aryl groups is preferably 6 or more and 10 or less, more preferably 6.

The diol unit (B) preferably includes at least one selected from the group consisting of a diol unit (B1) represented by formula (B1), a diol unit (B2) represented by formula (B2), a diol unit (B3) represented by formula (B3), a diol unit (B4) represented by formula (B4), a diol unit (B5) represented by formula (B5), a diol unit (B6) represented by formula (B6), a diol unit (B7) represented by formula (B7), and a diol unit (B8) represented by formula (B8).

The diol unit (B) more preferably includes at least one selected from the group consisting of the diol unit (B1) represented by formula (B1), the diol unit (B2) represented by formula (B2), the diol unit (B4) represented by formula (B4), the diol unit (B5) represented by formula (B5), and the diol unit (B6) represented by formula (B6),
still more preferably includes at least one selected from the group consisting of the diol unit (B1) represented by formula (B1), the diol unit (B2) represented by formula (B2), the diol unit (B5) represented by formula (B5), and the diol unit (B6) represented by formula (B6),
yet still more preferably includes at least one selected from the group consisting of the diol unit (B1) represented by formula (B1), the diol unit (B2) represented by formula (B2), and the diol unit (B6) represented by formula (B6), and
most preferably includes at least one selected from the group consisting of the diol unit (B1) represented by formula (B1), and the diol unit (B2) represented by formula (B2).

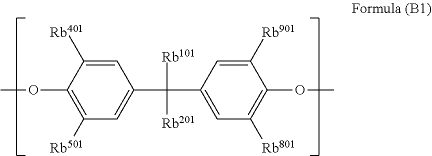

In formula (B1), Rb¹⁰¹ is a C4-C20 branched alkyl group, Rb²⁰¹ is a hydrogen atom or a C1-C3 alkyl group, and Rb⁴⁰¹, Rb⁵⁰¹, Rb⁸⁰¹, and Rb⁹⁰¹ are each independently a hydrogen atom, a C1-C4 alkyl group, a C1-C6 alkoxy group, or a halogen atom.

The number of carbon atoms in the C4-C20 branched alkyl group represented by Rb¹⁰¹ is preferably 4 or more and 16 or less, more preferably 4 or more and 12 or less, still more preferably 4 or more and 8 or less. Specific examples of Rb¹⁰¹ include isobutyl, sec-butyl, tert-butyl, isopentyl, neopentyl, tert-pentyl, isohexyl, sec-hexyl, tert-hexyl, isoheptyl, sec-heptyl, tert-heptyl, isooctyl, sec-octyl, tert-octyl, isononyl, sec-nonyl, tert-nonyl, isodecyl, sec-decyl, tert-decyl, isododecyl, sec-dodecyl, tert-dodecyl, tert-tetradecyl, and tert-pentadecyl groups.

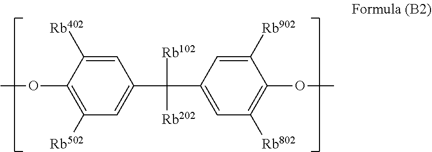

In formula (B2), Rb¹⁰² is a C4-C20 linear alkyl group, Rb²⁰² is a hydrogen atom or a C1-C3 alkyl group, and Rb⁴⁰², Rb⁵⁰², Rb⁸⁰², and Rb⁹⁰² are each independently a hydrogen atom, a C1-C4 alkyl group, a C1-C6 alkoxy group, or a halogen atom.

The number of carbon atoms in the C4-C20 linear alkyl group represented by Rb¹⁰² is preferably 4 or more and 16 or less, more preferably 4 or more and 12 or less, still more preferably 4 or more and 8 or less. Specific examples of Rb¹⁰² include n-butyl, n-pentyl, n-hexyl, n-heptyl, n-octyl, n-nonyl, n-decyl, n-undecyl, n-dodecyl, tridecyl, n-tetradecyl, n-pentadecyl, n-heptadecyl, n-octadecyl, n-nonadecyl, and n-icosyl groups.

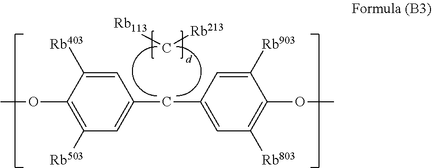

In formula (B3), Rb¹¹³ and Rb²¹³ are each independently a hydrogen atom, a C1-C3 linear alkyl group, a C1-C4 alkoxy group, or a halogen atom, d is an integer of 7 or more and 15 or less, and Rb⁴⁰³, Rb⁵⁰³, Rb⁸⁰³, and Rb⁹⁰³ are each independently a hydrogen atom, a C1-C4 alkyl group, a C1-C6 alkoxy group, or a halogen atom.

The number of carbon atoms in the C1-C3 linear alkyl groups represented by Rb¹¹³ and Rb²¹³ is preferably 1 or 2, more preferably 1. Specific examples of the groups include methyl, ethyl, and n-propyl groups.

The alkyl group in the C1-C4 alkoxy groups represented by Rb¹¹³ and Rb²¹³ may be linear, branched, or cyclic. The number of carbon atoms in the alkyl group in the C1-C4 alkoxy groups is preferably 1 or more and 3 or less, more preferably 1 or 2, still more preferably 1. Specific examples of the groups include methoxy, ethoxy, n-propoxy, n-butoxy, isopropoxy, isobutoxy, sec-butoxy, tert-butoxy, cyclopropoxy, and cyclobutoxy groups.

Examples of the halogen atom represented by Rb¹¹³ and Rb²¹³ include a fluorine atom, a chlorine atom, a bromine atom, and an iodine atom.

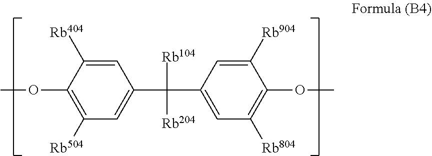

In formula (B4), Rb¹⁰⁴ and Rb²⁰⁴ are each independently a hydrogen atom or a C1-C3 alkyl group, and Rb⁴⁰⁴, Rb⁵⁰⁴, Rb⁸⁰⁴, and Rb⁹⁰⁴ are each independently a hydrogen atom, a C1-C4 alkyl group, a C1-C6 alkoxy group, or a halogen atom.

The C1-C3 alkyl group represented by Rb¹⁰⁴ may be linear, branched, or cyclic. The number of carbon atoms in the alkyl group is preferably 1 or 2, more preferably 1. Specific examples of Rb¹⁰⁴ include methyl, ethyl, n-propyl, isopropyl, and cyclopropyl groups.

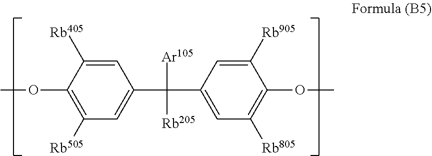

In formula (B5), Ar¹⁰⁵ is a C6-C12 aryl group or a C7-C20 aralkyl group, Rb²⁰⁵ is a hydrogen atom or a C1-C3 alkyl group, and Rb⁴⁰⁵, Rb⁵⁰⁵, Rb⁸⁰⁵, and Rb⁹⁰⁵ are each independently a hydrogen atom, a C1-C4 alkyl group, a C1-C6 alkoxy group, or a halogen atom.

The C6-C12 aryl group represented by Ar¹⁰⁵ may be monocyclic or polycyclic. The number of carbon atoms in the aryl group is preferably 6 or more and 10 or less, more preferably 6.

The alkyl group in the C7-C20 aralkyl group represented by Ar¹⁰⁵ may be linear, branched, or cyclic. The number of carbon atoms in the alkyl group in the C7-C20 aralkyl group is preferably 1 or more and 4 or less, more preferably 1 or more and 3 or less, still more preferably 1 or 2. The aryl group in the C7-C20 aralkyl group represented by Ar¹⁰⁵ may be monocyclic or polycyclic. The number of carbon atoms in the aryl group is preferably 6 or more and 10 or less, more preferably 6. Examples of the C7-C20 aralkyl group include benzyl, phenylethyl, phenylpropyl, 4-phenylbutyl, phenylpentyl, phenylhexyl, phenylheptyl, phenyloctyl, phenylnonyl, naphthylmethyl, naphthylethyl, anthracenylmethyl, and phenyl-cyclopentylmethyl groups.

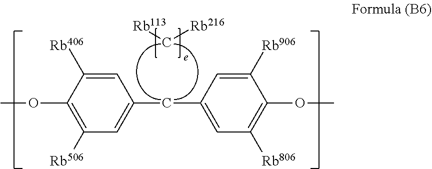

In formula (B6), Rb¹¹⁶ and Rb²¹⁶ are each independently a hydrogen atom, a C1-C3 linear alkyl group, a C1-C4 alkoxy group, or a halogen atom, e is an integer of 4 or more and 6 or less, and Rb⁴⁰⁶, Rb⁵⁰⁶, Rb⁸⁰⁶, and Rb⁹⁰⁶ are each independently a hydrogen atom, a C1-C4 alkyl group, a C1-C6 alkoxy group, or a halogen atom.

The number of carbon atoms in the C1-C3 linear alkyl groups represented by Rb¹¹⁶ and Rb²¹⁶ is preferably 1 or 2, more preferably 1. Specific examples of the groups include methyl, ethyl, and n-propyl groups.

The alkyl group in the C1-C4 alkoxy groups represented by Rb¹¹⁶ and Rb²¹⁶ may be linear, branched, or cyclic. The number of carbon atoms in the alkyl group in the C1-C4 alkoxy groups is preferably 1 or more and 3 or less, more preferably 1 or 2, still more preferably 1. Specific examples of the groups include methoxy, ethoxy, n-propoxy, n-butoxy, isopropoxy, isobutoxy, sec-butoxy, tert-butoxy, cyclopropoxy, and cyclobutoxy groups.

Examples of the halogen atom represented by Rb¹¹⁶ and Rb²¹⁶ include a fluorine atom, a chlorine atom, a bromine atom, and an iodine atom.

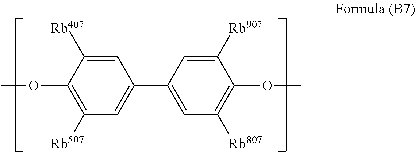

In formula (B7), Rb⁴⁰⁷, Rb⁵⁰⁷, Rb⁸⁰⁷, and Rb⁹⁰⁷ are each independently a hydrogen atom, a C1-C4 alkyl group, a C1-C6 alkoxy group, or a halogen atom.

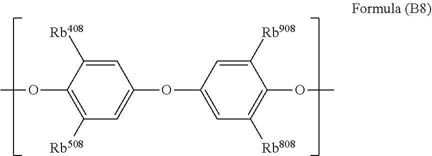

In formula (B8), Rb⁴⁰⁸, Rb⁵⁰⁸, Rb⁸⁰⁸, and Rb⁹⁰⁸ are each independently a hydrogen atom, a C1-C4 alkyl group, a C1-C6 alkoxy group, or a halogen atom.

Since Rb²⁰¹ in formula (B1), Rb²⁰² in formula (B2), Rb²⁰⁴ in formula (B4), and Rb²⁰⁵ in formula (B5) have the same specific forms and the same suitable forms, Rb²⁰¹, Rb²⁰², Rb²⁰⁴ and Rb²⁰⁵ are collectively referred to as “Rb²⁰⁰” in the following description.

The C1-C3 alkyl group represented by Rb²⁰⁰ may be linear, branched, or cyclic. The number of carbon atoms in the alkyl group is preferably 1 or 2, more preferably 1.

Examples of the C1-C3 alkyl group include methyl, ethyl, n-propyl, isopropyl, and cyclopropyl groups.

Since Rb⁴⁰¹ in formula (B1), Rb⁴⁰² in formula (B2), Rb⁴⁰³ in formula (B3), Rb⁴⁰⁴ in formula (B4), Rb⁴⁰⁵ in formula (B5), Rb⁴⁰⁶ in formula (B6), Rb⁴⁰⁷ in formula (B7), and Rb⁴⁰⁸ in formula (B8) have the same specific forms and the same suitable forms, Rb⁴⁰¹, Rb⁴⁰², Rb⁴⁰³, Rb⁴⁰⁴, Rb⁴⁰⁵, Rb⁴⁰⁶, Rb⁴⁰⁷, and Rb⁴⁰⁸ are collectively referred to as “Rb⁴⁰⁰” in the following description.

The C1-C4 alkyl group represented by Rb⁴⁰⁰ may be linear, branched, or cyclic. The number of carbon atoms in the alkyl group is preferably 1 or more and 3 or less, more preferably 1 or 2, still more preferably 1.

Examples of the C1-C4 linear alkyl group include methyl, ethyl, n-propyl, and n-butyl groups.

Examples of the C3-C4 branched alkyl group include isopropyl, isobutyl, sec-butyl, and tert-butyl groups.

Examples of the C3-C4 cyclic alkyl group include cyclopropyl and cyclobutyl groups.

The alkyl group in the C1-C6 alkoxy group represented by Rb⁴⁰⁰ may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C6 linear alkoxy group include methoxy, ethoxy, n-propoxy, n-butoxy, n-pentyloxy, and n-hexyloxy groups.

Examples of the C3-C6 branched alkoxy group include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group include cyclopropoxy, cyclobutoxy, cyclopentyloxy, and cyclohexyloxy groups.

Examples of the halogen atom represented by Rb⁴⁰⁰ include a fluorine atom, a chlorine atom, a bromine atom, and an iodine atom.

Since Rb⁵⁰¹ in formula (B1), Rb⁵⁰² in formula (B2), Rb⁵⁰³ in formula (B3), Rb⁵⁰⁴ in formula (B4), Rb⁵⁰⁵ in formula (B5), Rb⁵⁰⁶ in formula (B6), Rb⁵⁰⁷ in formula (B7), and Rb⁵⁰⁸ in formula (B8) have the same specific forms and the same suitable forms, Rb⁵⁰¹, Rb⁵⁰², Rb⁵⁰³, Rb⁵⁰⁴, Rb⁵⁰⁵, Rb⁵⁰⁶, Rb⁵⁰⁷, and Rb⁵⁰⁸ are collectively referred to as “Rb⁵⁰⁰” in the following description.

The C1-C4 alkyl group represented by Rb⁵⁰⁰ may be linear, branched, or cyclic. The number of carbon atoms in the alkyl group is preferably 1 or more and 3 or less, more preferably 1 or 2, still more preferably 1.

Examples of the C1-C4 linear alkyl group include methyl, ethyl, n-propyl, and n-butyl groups.

Examples of the C3-C4 branched alkyl group include isopropyl, isobutyl, sec-butyl, and tert-butyl groups.

Examples of the C3-C4 cyclic alkyl group include cyclopropyl and cyclobutyl groups.

The alkyl group in the C1-C6 alkoxy group represented by Rb⁵⁰⁰ may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C6 linear alkoxy group include methoxy, ethoxy, n-propoxy, n-butoxy, n-pentyloxy, and n-hexyloxy groups.

Examples of the C3-C6 branched alkoxy group include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group include cyclopropoxy, cyclobutoxy, cyclopentyloxy, and cyclohexyloxy groups.

Examples of the halogen atom represented by Rb⁵⁰⁰ include a fluorine atom, a chlorine atom, a bromine atom, and an iodine atom.

Since Rb⁸⁰¹ in formula (B1), Rb⁸⁰² in formula (B2), Rb⁸⁰³ in formula (B3), Rb⁸⁰⁴ in formula (B4), Rb⁸⁰⁵ in formula (B5), Rb⁸⁰⁶ in formula (B6), Rb⁸⁰⁷ in formula (B7), and Rb⁸⁰⁸ in formula (B8) have the same specific forms and the same suitable forms, Rb⁸⁰¹, Rb⁸⁰², Rb⁸⁰³, Rb⁸⁰⁴, Rb⁸⁰⁵, Rb⁸⁰⁶, Rb⁸⁰⁷, and Rb⁸⁰⁸ are collectively referred to as “Rb⁸⁰⁰” in the following description.

The C1-C4 alkyl group represented by Rb⁸⁰⁰ may be linear, branched, or cyclic. The number of carbon atoms in the alkyl group is preferably 1 or more and 3 or less, more preferably 1 or 2, still more preferably 1.

Examples of the C1-C4 linear alkyl group include methyl, ethyl, n-propyl, and n-butyl groups.

Examples of the C3-C4 branched alkyl group include isopropyl, isobutyl, sec-butyl, and tert-butyl groups.

Examples of the C3-C4 cyclic alkyl group include cyclopropyl and cyclobutyl groups.

The alkyl group in the C1-C6 alkoxy group represented by Rb⁸⁰⁰ may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C6 linear alkoxy group include methoxy, ethoxy, n-propoxy, n-butoxy, n-pentyloxy, and n-hexyloxy groups.

Examples of the C3-C6 branched alkoxy group include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group include cyclopropoxy, cyclobutoxy, cyclopentyloxy, and cyclohexyloxy groups.

Examples of the halogen atom represented by Rb⁸⁰⁰ include a fluorine atom, a chlorine atom, a bromine atom, and an iodine atom.

Since Rb⁹⁰¹ in formula (B1), Rb⁹⁰² in formula (B2), Rb⁹⁰³ in formula (B3), Rb⁹⁰⁴ in formula (B4), Rb⁹⁰⁵ in formula (B5), Rb⁹⁰⁶ in formula (B6), Rb⁹⁰⁷ in formula (B7), and Rb⁹⁰⁸ in formula (B8) have the same specific forms and the same suitable forms, Rb⁹⁰¹, Rb⁹⁰², Rb⁹⁰³, Rb⁹⁰⁴, Rb⁹⁰⁵, Rb⁹⁰⁶, Rb⁹⁰⁷, and Rb⁹⁰⁸ are collectively referred to as “Rb⁹⁰⁰” in the following description.

The C1-C4 alkyl group represented by Rb⁹⁰⁰ may be linear, branched, or cyclic. The number of carbon atoms in the alkyl group is preferably 1 or more and 3 or less, more preferably 1 or 2, still more preferably 1.

Examples of the C1-C4 linear alkyl group include methyl, ethyl, n-propyl, and n-butyl groups.

Examples of the C3-C4 branched alkyl group include isopropyl, isobutyl, sec-butyl, and tert-butyl groups.

Examples of the C3-C4 cyclic alkyl group include cyclopropyl and cyclobutyl groups.

The alkyl group in the C1-C6 alkoxy group represented by Rb⁹⁰⁰ may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C6 linear alkoxy group include methoxy, ethoxy, n-propoxy, n-butoxy, n-pentyloxy, and n-hexyloxy groups.

Examples of the C3-C6 branched alkoxy group include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group include cyclopropoxy, cyclobutoxy, cyclopentyloxy, and cyclohexyloxy groups.

Examples of the halogen atom represented by Rb⁹⁰⁰ include a fluorine atom, a chlorine atom, a bromine atom, and an iodine atom.

Diol units (B1-1) to (B1-6) are shown below as specific examples of the diol unit (B1). The diol unit (B1) is not limited to these.

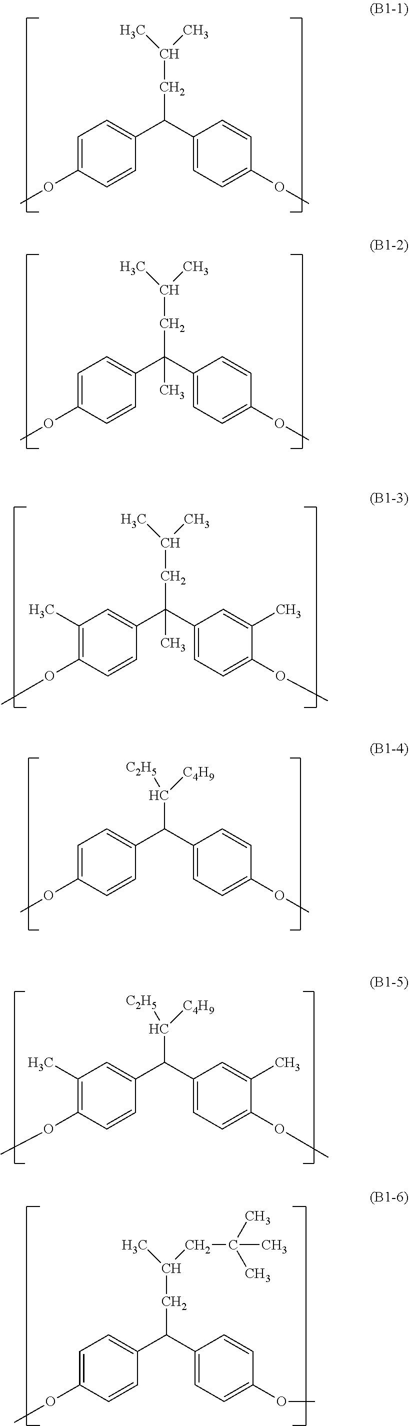

Diol units (B2-1) to (B2-11) are shown below as specific examples of the diol unit (B2). The diol unit (B2) is not limited to these.

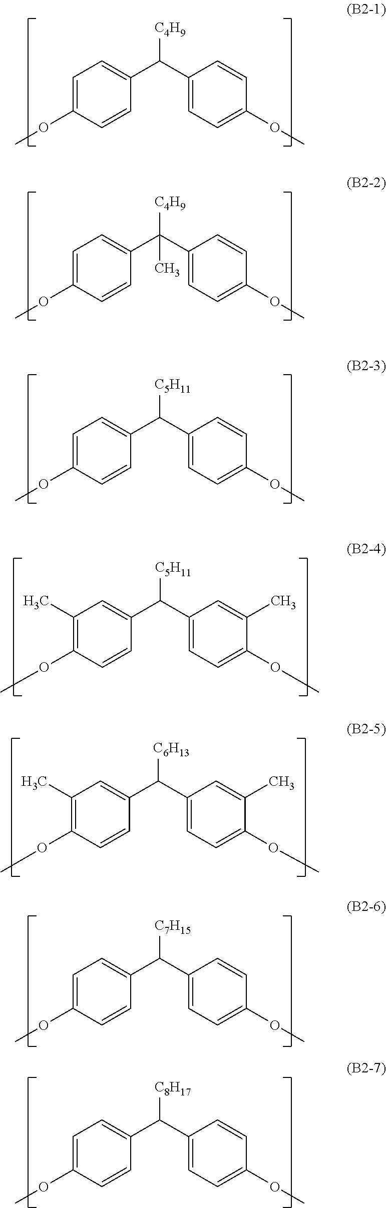

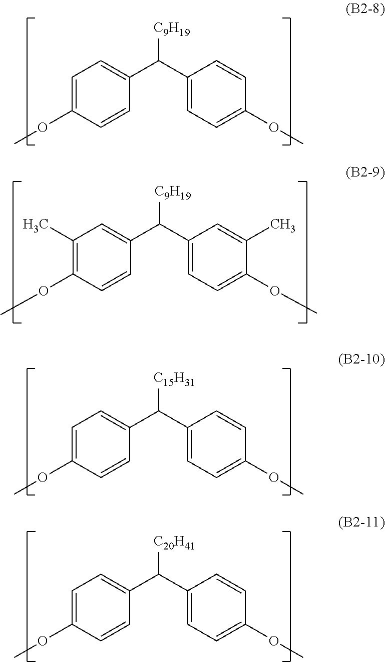

Diol units (B3-1) to (B3-4) are shown below as specific examples of the diol unit (B3). The diol unit (B3) is not limited to these.

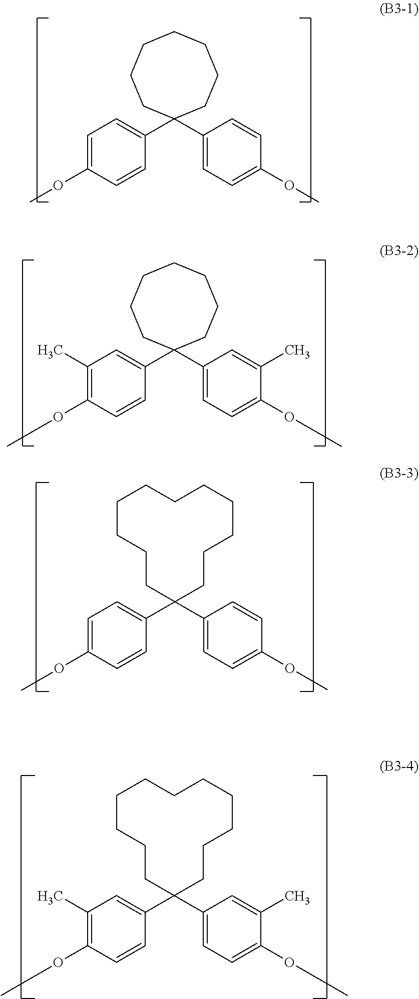

Diol units (B4-1) to (B4-7) are shown below as specific examples of the diol unit (B4). The diol unit (B4) is not limited to these.

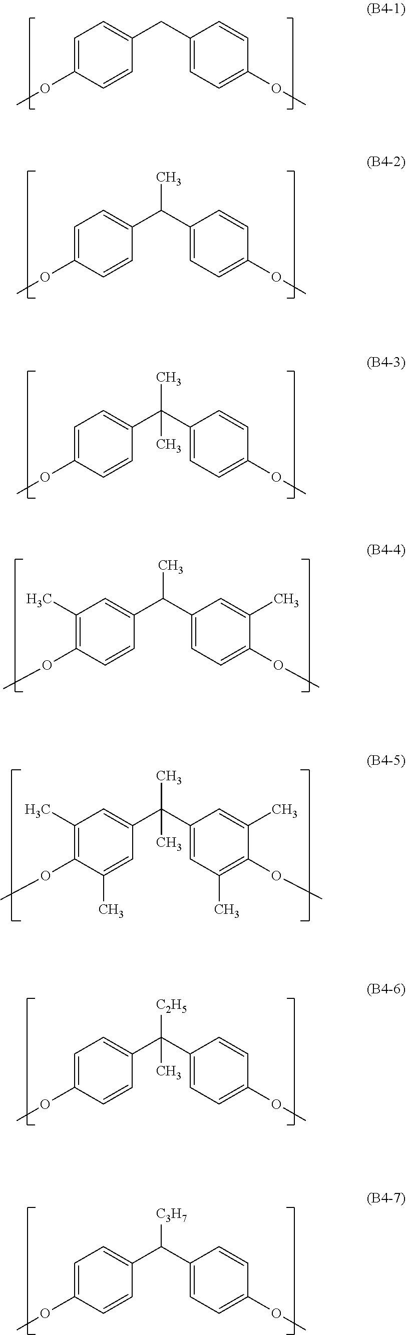

Diol units (B5-1) to (B5-6) are shown below as specific examples of the diol unit (B5). The diol unit (B5) is not limited to these.

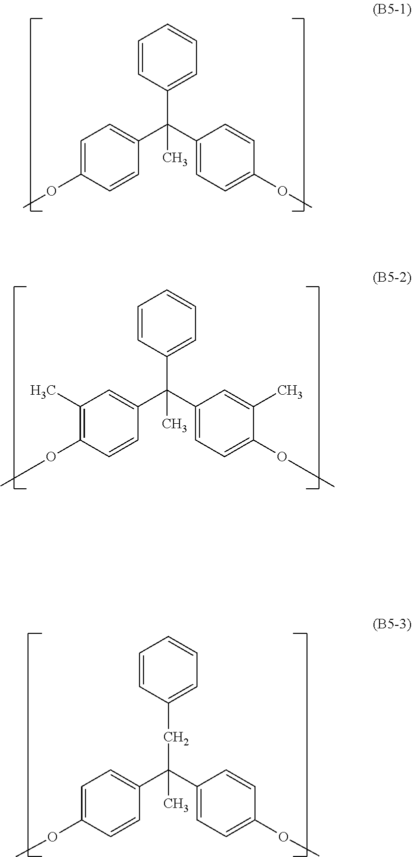

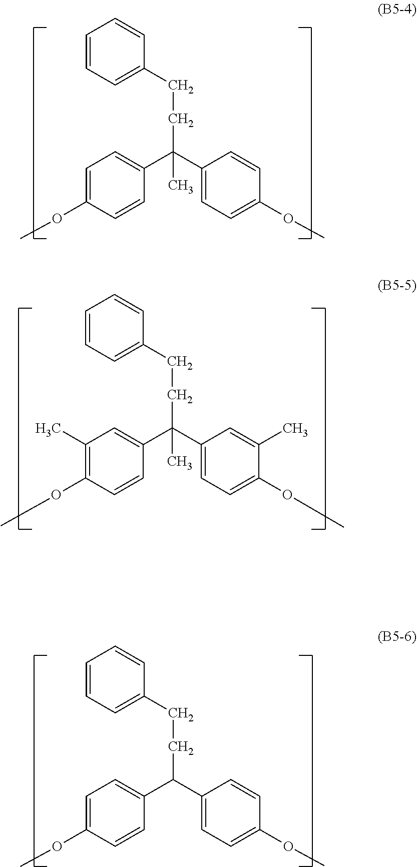

Diol units (B6-1) to (B6-4) are shown below as specific examples of the diol unit (B6). The diol unit (B6) is not limited to these.

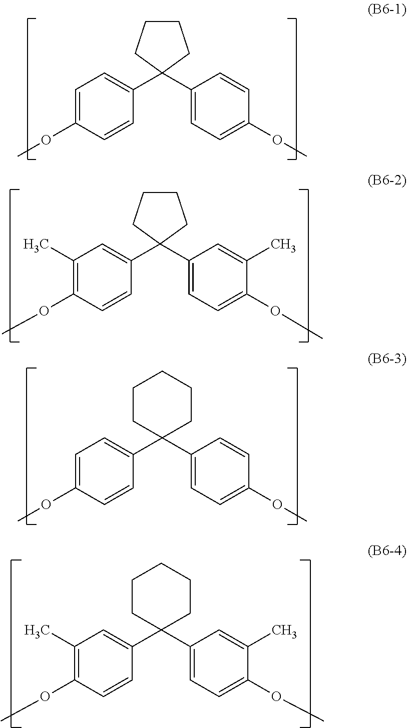

Diol units (B7-1) to (B7-3) are shown below as specific examples of the diol unit (B7). The diol unit (B7) is not limited to these.

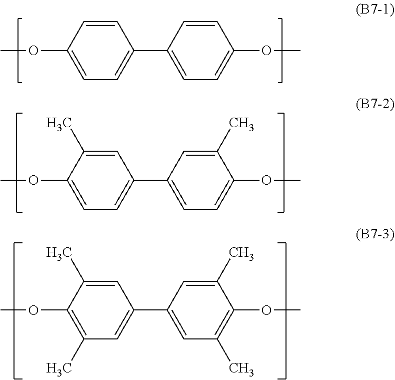

Diol units (B8-1) to (B8-3) are shown below as specific examples of the diol unit (B8). The diol unit (B8) is not limited to these.

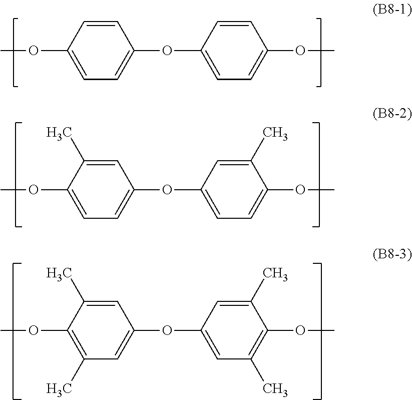

The polyester resin (1) may include one type or two or more types of diol units (B).

The mass ratio of the diol unit (B) in the polyester resin (1) is preferably 25 mass % or more and 80 mass % or less.

When the mass ratio of the diol unit (B) is 25 mass % or more, the photosensitive layer is less likely to peel off. From this viewpoint, the mass ratio of the diol unit (B) is more preferably 30 mass % or more, still more preferably 35 mass % or more.

When the mass ratio of the diol unit (B) is 80 mass % or less, the polyarylate resin (1) may keep solubility in a coating liquid for forming the photosensitive layer and can thus improve wear resistance. From this viewpoint, the mass ratio of the diol unit (B) is more preferably 75 mass % or less, still more preferably 70 mass % or less.

Examples of another diol unit other than the diol unit (B) include aliphatic diol (e.g., ethylene glycol, diethylene glycol, triethylene glycol, propylene glycol, butanediol, hexanediol, and neopentyl glycol) units, and alicyclic diol (e.g., cyclohexanediol, cyclohexanedimethanol, hydrogenated bisphenol A) units. The polyester resin (1) may include one type or two or more types of these diol units.

The terminals of the polyester resin (1) may be capped or modified with a terminal capping agent, a molecular weight regulator, or other agents used in production. Examples of the terminal capping agent or the molecular weight regulator include monohydric phenols, monovalent acid chlorides, monohydric alcohols, and monocarboxylic acids.

Examples of monohydric phenols include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, 2,6-dimethylphenol derivatives, 2-methylphenol derivatives, o-phenylphenol, m-phenylphenol, p-phenylphenol, o-methoxyphenol, m-methoxyphenol, p-methoxyphenol, 2,3,5-trimethylphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl) propane, 2-phenyl-2-(2-hydroxyphenyl) propane, and 2-phenyl-2-(3-hydroxyphenyl) propane.

Examples of monovalent acid chlorides include monofunctional acid halides, such as benzoyl chloride, benzoic acid chloride, methanesulfonyl chloride, phenyl chloroformate, acetyl chloride, butyryl chloride, octanoyl chloride, benzenesulfonyl chloride, benzenesulfinyl chloride, sulfinyl chloride, benzenephosphonyl chloride, and substituted products thereof.

Examples of monohydric alcohols include methanol, ethanol, n-propanol, isopropanol, n-butanol, 2-butanol, pentanol, hexanol, dodecyl alcohol, stearyl alcohol, benzyl alcohol, and phenethyl alcohol.

Examples of monocarboxylic acids include acetic acid, propionic acid, octanoic acid, cyclohexanecarboxylic acid, benzoic acid, toluic acid, phenylacetic acid, p-tert-butylbenzoic acid, and p-methoxyphenylacetic acid.

When two or more polyester resins (1) having different weight average molecular weights are mixed, and the mixed polyester resins (1) are used to form the photosensitive layer, the weight average molecular weight of each polyester resin (1) before mixing is preferably 30,000 or more and 300,000 or less, more preferably 40,000 or more and 250,000 or less, still more preferably 50,000 or more and 200,000 or less.

The molecular weight of the polyester resins (1) is the polystyrene-equivalent molecular weight determined by gel permeation chromatography (GPC). In GPC, tetrahydrofuran is used as an eluent.

The polyester resin (1) may be prepared by, for example, polycondensation of a monomer providing the dicarboxylic acid unit (A), a monomer providing the diol unit (B), and other optional monomers in accordance with a conventional method. Examples of monomer polycondensation methods include interfacial polymerization, solution polymerization, and melt polymerization. Interfacial polymerization is a polymerization method in which polyester is produced by mixing a dicarboxylic acid halide dissolved in an organic solvent incompatible with water and a dihydric alcohol dissolved in an aqueous alkaline solution. Examples of documents on interfacial polymerization include W. M. EARECKSON, J. Poly. Sci., XL399, 1959 and Japanese Examined Patent Application Publication No. 40-1959. In interfacial polymerization, the reaction proceeds more quickly than in solution polymerization, so that the dicarboxylic acid halide is less likely to undergo hydrolysis, and as a result, a polyester resin with a high molecular weight may be produced.

### Conductive Substrate

Examples of the conductive substrate include metal plates, metal drums, and metal belts containing metals (e.g., aluminum, copper, zinc, chromium, nickel, molybdenum, vanadium, indium, gold, and platinum) or alloys (e.g., stainless steel). Examples of the conductive substrate also include conductive compound (e.g., conductive polymer, indium oxide), metal (e.g., aluminum, palladium, gold), or alloy-coated, -vapor-deposited, or -laminated paper, resin films, and belts. The term “conductive” means that the volume resistivity is less than 1×10¹³ Ω·cm.

The surface of the conductive substrate may be roughened into a center-line average roughness Ra of 0.04 μm or more and 0.5 μm or less in order to prevent or reduce interference fringes generated by irradiation with laser light when the electrophotographic photoreceptor is used in a laser printer. When incoherent light is used as a light source, surface roughening for preventing interference fringes is not required but suitable for longer life since it prevents generation of defects otherwise caused by surface unevenness of the conductive substrate.

Examples of the surface roughening method include: wet honing in which a suspension of an abrasive in water is sprayed onto the conductive substrate; centerless grinding in which the conductive substrate is continuously ground while being pressed against a rotating grindstone; and an anodizing treatment.

Examples of the surface roughening method also include a method in which a dispersion of a conductive or semiconductive powder in a resin is applied to the surface of a conductive substrate without roughing the surface of the conductive substrate to form a layer on the surface of the conductive substrate so that the particles dispersed in the layer form a rough surface.

The surface roughing treatment by anodization involves anodizing a metal (e.g., aluminum) conductive substrate, which is used as an anode, in an electrolyte solution to form an oxide film on the surface of the conductive substrate. Examples of the electrolyte solution include a sulfuric acid solution and an oxalic acid solution. However, a porous anodized film formed by anodization is chemically active, easily contaminated, and greatly varies in resistance depending on the environment as it is. For this, the porous anodized film may be subjected to pore-sealing in which the fine pores of the anodized film are sealed by volume expansion caused by the hydration reaction in pressurized steam or boiling water (may contain a metal salt, such as a nickel salt), resulting in a more stable hydrated oxide.

The anodized film may have a film thickness of, for example, 0.3 μm or more and 15 μm or less. When the film thickness is in the above range, the anodized film tends to function as a barrier against injection and tends to prevent or reduce an increase in residual potential caused by repeated use.

The conductive substrate may be subjected to the treatment with an acid treatment liquid or the bochmite treatment.

The treatment with an acid treatment liquid is carried out, for example, as described below. First, an acid treatment liquid containing phosphoric acid, chromic acid, and hydrofluoric acid is prepared. With regard to the mixing ratios of phosphoric acid, chromic acid, and hydrofluoric acid in the acid treatment liquid, the acid treatment liquid contains, for example, phosphoric acid in the range of 10 mass % or more and 11 mass % or less, chromic acid in the range of 3 mass % or more and 5 mass % or less, and hydrofluoric acid in the range of 0.5 mass % or more and 2 mass % or less. The total concentration of these acids may be in the range of 13.5 mass % or more and 18 mass % or less. The treatment temperature may be, for example, 42° C. or higher and 48° C. or lower. The coating film may have a film thickness of, for example, 0.3 μm or more and 15 μm or less.

The bochmite treatment involves, for example, dipping the conductive substrate in pure water of 90° C. or higher and 100° C. or lower for 5 minutes to 60 minutes or bringing the conductive substrate into contact with hot steam of 90° C. or higher and 120° C. or lower for 5 minutes to 60 minutes. The coating film may have a film thickness of, for example, 0.1 μm or more and 5 μm or less. The conductive substrate may be further subjected to the anodizing treatment using an electrolyte solution in which the coating film is less soluble, such as adipic acid, boric acid, a borate salt, a phosphate salt, a phthalate salt, a maleate salt, a benzoate salt, a tartrate salt, or a citrate salt.

### Undercoat Layer

The undercoat layer is, for example, a layer containing inorganic particles and a binder resin.

Examples of the inorganic particles include inorganic particles having a powder resistance (volume resistivity) of 1×10² Ω·cm or more and 1×10¹¹ Ω·cm or less.

In particular, the inorganic particles having the above resistance value are, for example, preferably metal oxide particles, such as tin oxide particles, titanium oxide particles, zinc oxide particles, or zirconium oxide particles, more preferably zinc oxide particles.

The inorganic particles may have a BET specific surface area of, for example, 10 m²/g or more.

The inorganic particles may have a volume average particle size of, for example, 50 nm or more and 2000 nm or less (e.g., 60 nm or more and 1000 nm or less).

The amount of the inorganic particles relative to the binder resin is, for example, preferably 10 mass % or more and 80 mass % or less, more preferably 40 mass % or more and 80 mass % or less.

The inorganic particles may be surface-treated. The inorganic particles may be a mixture of two or more types of differently surface-treated inorganic particles or two or more types of inorganic particles having different particle sizes.

Examples of the surface treatment agent include silane coupling agents, titanate coupling agents, aluminum coupling agents, and surfactants. In particular, silane coupling agents are preferred, and silane coupling agents having amino groups are more preferred.

Examples of silane coupling agents having amino groups include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

The silane coupling agents may be used as a mixture of two or more. For example, a silane coupling agent having an amino group and another silane coupling agent may be used in combination. Examples of another silane coupling agent include, but are not limited to, vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method using a surface treatment agent may be any one of known methods and may be a dry method or a wet method.

The amount of the surface treatment agent used may be, for example, 0.5 mass % or more and 10 mass % or less relative to the inorganic particles.

The undercoat layer may contain an electron-accepting compound (acceptor compound) as well as the inorganic particles because this composition improves the long-term stability of electrical properties and the carrier blocking properties.

Examples of the electron-accepting compound include electron-transporting substances, such as quinone compounds, such as chloranil and bromoanil; tetracyanoquinodimethane compounds; fluorenone compounds, such as 2,4,7-trinitrofluorenone and 2,4,5,7-tetranitro-9-fluorenone; oxadiazole compounds, such as 2-(4-biphenyl)-5-(4-t-butylphenyl)-1,3,4-oxadiazole, 2,5-bis(4-naphthyl)-1,3,4-oxadiazole, 2,5-bis(4-diethylaminophenyl)-1,3,4-oxadiazole; xanthone compounds; thiophene compounds; diphenoquinone compounds, such as 3,3′,5,5′-tetra-t-butyldiphenoquinone; and benzophenone compounds.

In particular, the electron-accepting compound may be a compound having an anthraquinone structure. Examples of the compound having an anthraquinone structure include hydroxyanthraquinone compounds, aminoanthraquinone compounds, and aminohydroxyanthraquinone compounds. Specific examples include anthraquinone, alizarin, quinizarin, anthralphine, purpurin, and derivatives thereof.

The electron-accepting compound may be dispersed together with the inorganic particles in the undercoat layer, or may be attached to the surfaces of the inorganic particles in the undercoat layer.

Examples of the method for attaching the electron-accepting compound to the surfaces of the inorganic particles include dry methods and wet methods.

An example of dry methods involves, while stirring the inorganic particles in, for example, a mixer with a large shear force, adding an electron-accepting compound dropwise directly or in the form of a solution in an organic solvent or spraying the electron-accepting compound together with dry air or nitrogen gas so that the electron-accepting compound is attached to the surfaces of the inorganic particles. The electron-accepting compound is added dropwise or sprayed at a temperature lower than or equal to the boiling point of the solvent. After the electron-accepting compound is added dropwise or sprayed, baking at 100° C. or higher may further be performed. The temperature and time of baking are not limited as long as the electrophotographic properties are obtained.

An example of wet methods involves, while dispersing the inorganic particles in a solvent by using a stirrer, an ultrasonic disperser, a sand mill, an attritor, or a ball mill, or other means, adding an electron-accepting compound, stirring or dispersing it, and then removing the solvent so that the electron-accepting compound is attached to the surfaces of the inorganic particles. The solvent removal method involves, for example, filtering or evaporating the solvent off. After solvent removal, baking at 100° C. or higher may further be performed. The temperature and time of baking are not limited as long as the electrophotographic properties are obtained. In a wet method, water contained in the inorganic particles may be removed before adding the electron-accepting compound. For example, water may be removed by heating under stirring in the solvent, or water may be removed by boiling together with the solvent.

The attachment of the electron-accepting compound may be performed before or after the inorganic particles are surface-treated with a surface treatment agent, or the attachment of the electron-accepting compound and the surface treatment with a surface treatment agent may be performed at the same time.

The amount of the electron-accepting compound relative to the inorganic particles is, for example, 0.01 mass % or more and 20 mass % or less, preferably 0.01 mass % or more and 10 mass % or less.

Examples of the binder resin used in the undercoat layer include known polymer compounds, such as acetal resins (e.g., polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenol resins, phenol-formaldehyde resins, melamine resins, urethane resins, alkyd resins, and epoxy resins; zirconium chelate compounds; titanium chelate compounds; aluminum chelate compounds; titanium alkoxide compounds; organic titanium compounds; and silane coupling agents.

Examples of the binder resin used in the undercoat layer also include charge-transporting resins having charge-transporting groups, and conductive resins (e.g., polyaniline).

In particular, the binder resin used in the undercoat layer is preferably a resin insoluble in the coating solvent for the overlying layer, more preferably a resin produced by the reaction between a curing agent and at least one resin selected from the group consisting of thermosetting resins, such as urea resins, phenol resins, phenol-formaldehyde resins, melamine resins, urethane resins, unsaturated polyester resins, alkyd resins, and epoxy resins; polyamide resins, polyester resins, polyether resins, methacrylic resins, acrylic resins, polyvinyl alcohol resins, and polyvinyl acetal resins.

When two or more of these binder resins are used in combination, the mixing ratio of the binder resins is set as needed.

The undercoat layer may contain various additives to improve electrical properties, environmental stability, and image quality.

Examples of the additives include known materials, such as polycyclic condensation-type and azo-type electron-transporting pigments, zirconium chelate compounds, titanium chelate compounds, aluminum chelate compounds, titanium alkoxide compounds, organic titanium compounds, and silane coupling agents. The silane coupling agent is used in the surface treatment of the inorganic particles as described above, but may further be added to the undercoat layer as an additive.

Examples of the silane coupling agent used as an additive include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of zirconium chelate compounds include zirconium butoxide, ethyl zirconium acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octoate, zirconium naphthenate, zirconium laurate, zirconium stearate, zirconium isostearate, methacrylate zirconium butoxide, stearate zirconium butoxide, and isostearate zirconium butoxide.

Examples of titanium chelate compounds include tetraisopropyl titanate, tetra-n-butyl titanate, butyl titanate dimer, tetra(2-ethylhexyl) titanate, titanium acetylacetonate, polytitanium acetylacetonate, titanium octylene glycolate, titanium lactate ammonium salt, titanium lactate, titanium ethyl ester, titanium triethanolaminate, and polyhydroxytitanium stearate.

Examples of the aluminum chelate compounds include aluminum isopropylate, monobutoxyaluminum diisopropylate, aluminum butyrate, diethyl acetoacetate aluminum diisopropylate, and aluminum tris(ethylacetoacetate).

These additives may be used singly or used as a mixture or polycondensate of two or more compounds.

The undercoat layer may have a Vickers hardness of 35 or more.

To prevent or reduce moire fringes, the surface roughness (ten-point average roughness) of the undercoat layer may be adjusted in the range of from 1/(4n) (n represents the refractive index of the overlying layer) to ½ of the laser wavelength λ for exposure.

To adjust the surface roughness, the undercoat layer may contain resin particles and the like. Examples of the resin particles include silicone resin particles and cross-linked polymethyl methacrylate resin particles. The surface of the undercoat layer may be polished to adjust the surface roughness. Examples of the polishing method include buff polishing, sand blasting, wet honing, and grinding.

The undercoat layer may be formed by any of known forming methods. For example, a coating liquid for forming the undercoat layer is prepared by adding the above components to a solvent, and a coating film of the coating liquid is formed, dried, and heated as needed.

Examples of the solvent used for preparing the coating liquid for forming the undercoat layer include known organic solvents, such as alcohol solvents, aromatic hydrocarbon solvents, halogenated hydrocarbon solvents, ketone solvents, ketone-alcohol solvents, ether solvents, and ester solvents.

Specific examples of these solvents include common organic solvents, such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method for dispersing the inorganic particles to prepare the coating liquid for forming the undercoat layer include known methods using a roll mill, a ball mill, a vibrating ball mill, an attritor, a sand mill, a colloid mill, a paint shaker, or the like.

Examples of the method for applying the coating liquid for forming the undercoat layer onto the conductive substrate include common methods, such as a blade coating method, a wire bar coating method, a spray coating method, a dip coating method, a bead coating method, an air knife coating method, and a curtain coating method.

The film thickness of the undercoat layer is preferably set to, for example, 15 μm or more, more preferably in the range of 20 μm or more and 50 μm or less.

### Intermediate Layer

An intermediate layer may be further disposed between the undercoat layer and the photosensitive layer.

The intermediate layer is, for example, a layer containing a resin. Examples of the resin used in the intermediate layer include polymer compounds, such as acetal resins (e.g., polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer containing an organometallic compound. Examples of the organometallic compound used in the intermediate layer include organometallic compounds containing a metal atom, such as zirconium, titanium, aluminum, manganese, or silicon.

These compounds used in the intermediate layer may be used singly or used as a mixture or polycondensate of two or more compounds.

In particular, the intermediate layer may be a layer containing an organometallic compound containing a zirconium atom or a silicon atom.

The intermediate layer may be formed by any of known forming methods. For example, a coating liquid for forming the intermediate layer is prepared by adding the above components to a solvent, and a coating film of the coating liquid is formed, dried, and heated as needed.

Examples of the coating method for forming the intermediate layer include common methods, such as a dip coating method, a lift coating method, a wire bar coating method, a spray coating method, a blade coating method, an air knife coating method, and a curtain coating method.

The film thickness of the intermediate layer may be set, for example, in the range of 0.1 μm or more and 3 μm or less. The intermediate layer may be used as the undercoat layer.

### Charge Generation Layer

The charge generation layer is, for example, a layer containing a charge-generating material and a binder resin. The charge generation layer may be a layer formed by vapor deposition of the charge-generating material. The layer formed by vapor deposition of the charge-generating material is suitable for the case of using an incoherent light source, such as a light emitting diode (LED) or an organic electroluminescence (EL) image array.

Examples of the charge-generating material include azo pigments, such as bisazo and trisazo pigments; fused-ring aromatic pigments, such as dibromoanthanthrone; perylene pigments; pyrrolopyrrole pigments; phthalocyanine pigments; zinc oxide; and trigonal selenium.

For laser exposure in the near-infrared region, the charge-generating material is preferably a metal phthalocyanine pigment or a metal-free phthalocyanine pigment. Specifically, for example, hydroxygallium phthalocyanine, chlorogallium phthalocyanine, dichlorotin phthalocyanine, and titanyl phthalocyanine are more preferred.

For laser exposure in the near-ultraviolet region, the charge-generating material is preferably, for example, a fused-ring aromatic pigment, such as dibromoanthanthrone, a thioindigo pigment, a porphyrazine compound, zinc oxide, trigonal selenium, or a bisazo pigment.

In the case of using an incoherent light source, such as an LED or organic EL image array having an emission center wavelength of 450 nm or more and 780 nm or less, the charge-generating material described above may also be used.

When an n-type semiconductor, such as a fused-ring aromatic pigment, a perylene pigment, or an azo pigment, is used as the charge-generating material, a dark current is difficult to generate, and image defects called black spots may be prevented or reduced even in a thin film. Whether the material is of n-type or not is determined by using a common time-of-flight method on the basis of the polarity of a flowing photocurrent, and a material that allows electrons to flow more easily as carriers than holes is determined to be of n-type.

The binder resin used in the charge generation layer is selected from a wide range of insulating resins, and may be selected from organic photoconductive polymers, such as poly-N-vinylcarbazole, polyvinyl anthracene, polyvinyl pyrene, and polysilane.

Examples of the binder resin include polyvinyl butyral resins, polyarylate resins (e.g., polycondensates of bisphenols and divalent aromatic carboxylic acids), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinylpyrrolidone resins. The term “insulating” as used herein means that the volume resistivity is 1×10¹³ Ω·cm or more.

These binder resins are used singly or as a mixture of two or more.

The blending ratio of the charge-generating material to the binder resin may be in the range of from 10:1 to 1:10 in terms of mass ratio.

The charge generation layer may contain other known additives.

The charge generation layer may be formed by any of known forming methods. For example, a coating liquid for forming the charge generation layer is prepared by adding the above components to a solvent, and a coating film of the coating liquid is formed, dried, and heated as needed. The charge generation layer may be formed by vapor deposition of the charge-generating material. The formation of the charge generation layer by vapor deposition is suitable for the case of using a fused-ring aromatic pigment or a perylene pigment as the charge-generating material.

Examples of the solvent used for preparing the coating liquid for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used singly or as a mixture of two or more.

Examples of the method for dispersing particles (e.g., charge-generating material) in the coating liquid for forming the charge generation layer include methods using a media disperser, such as a ball mill, a vibrating ball mill, an attritor, a sand mill, or a horizontal sand mill, or a medialess disperser, such as a stirrer, an ultrasonic disperser, a roll mill, or a high-pressure homogenizer. Examples of the high-pressure homogenizer include a collision-type homogenizer in which a dispersion is formed through liquid-liquid collision or liquid-wall collision under high pressure, and a penetration-type homogenizer in which a dispersion is formed by passing the mixture through a fine flow path under high pressure.

This dispersion is effectively formed when the charge-generating material in the coating liquid for forming the charge generation layer has an average particle size of 0.5 μm or less, preferably 0.3 μm or less, more preferably 0.15 μm or less.

Examples of the method for applying the coating liquid for forming the charge generation layer onto the undercoat layer (or onto the intermediate layer) include common methods, such as a blade coating method, a wire bar coating method, a spray coating method, a dip coating method, a bead coating method, an air knife coating method, and a curtain coating method.

The film thickness of the charge generation layer is preferably set, for example, in the range of 0.1 μm or more and 5.0 μm or less, more preferably in the range of 0.2 μm or more and 2.0 μm or less.

### Charge Transport Layer

The charge transport layer contains a charge-transporting material and a binder resin.

Examples of the charge-transporting material include electron-transporting compounds, such as quinone compounds, such as p-benzoquinone, chloranil, bromanil, and anthraquinone; tetracyanoquinodimethane compounds; fluorenone compounds, such as 2,4,7-trinitrofluorenone; xanthone compounds; benzophenone compounds; cyanovinyl compounds; and ethylene compounds. Examples of the charge-transporting material also include hole-transporting compounds, such as triarylamine compounds, benzidine compounds, arylalkane compounds, aryl-substituted ethylene compounds, stilbene compounds, anthracene compounds, and hydrazone compounds. These charge-transporting materials are used singly or in combination of two or more. The charge-transporting materials are not limited to these compounds.

The charge-transporting material may be a polymer charge-transporting material. Examples of the polymer charge-transporting materials include known compounds having charge-transporting properties, such as poly-N-vinylcarbazole or polysilane. In particular, polyester-based polymer charge-transporting materials may be used.

Examples of the charge-transporting material or the polymer charge-transporting material include polycyclic aromatic compounds, aromatic nitro compounds, aromatic amine compounds, heterocyclic compounds, hydrazone compounds, styryl compounds, enamine compounds, benzidine compounds, triarylamine compounds (especially triphenylamine compounds), diamine compounds, oxadiazole compounds, carbazole compounds, organic polysilane compounds, pyrazoline compounds, indole compounds, oxazole compounds, isoxazole compounds, thiazole compounds, thiadiazole compounds, imidazole compounds, pyrazole compounds, triazole compounds, cyano compounds, benzofuran compounds, aniline compounds, butadiene compounds, and resins having groups derived from these substances. Specific examples include compounds described in paragraphs 0078 to 0080 in Japanese Unexamined Patent Application Publication No. 2021-117377, paragraphs 0046 to 0048 in Japanese Unexamined Patent Application Publication No. 2019-035900, paragraphs 0052 to 0053 in Japanese Unexamined Patent Application Publication No. 2019-012141, paragraphs 0122 to 0134 in Japanese Unexamined Patent Application Publication No. 2021-071565, paragraphs 0101 to 0110 in Japanese Unexamined Patent Application Publication No. 2021-015223, paragraph 0116 in Japanese Unexamined Patent Application Publication No. 2013-097300, paragraphs 0309 to 0316 in International Publication No. WO 2019/070003, paragraphs 0103 to 0107 in Japanese Unexamined Patent Application Publication No. 2018-159087, and paragraphs 0102 to 0113 in Japanese Unexamined Patent Application Publication No. 2021-148818.

From the viewpoint of charge mobility, the charge-transporting material may contain at least one selected from the group consisting of a compound (C1) represented by formula (C1), a compound (C2) represented by formula (C2), a compound (C3) represented by formula (C3), and a compound (C4) represented by formula (C4).

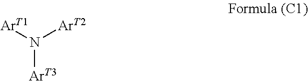

In formula (C1), Ar^{T1}, Ar^{T2}, and Ar^{T3} are each independently an aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} are each independently a hydrogen atom, an alkyl group, or an aryl group. When R^{T5} and R^{T6} are aryl groups, the aryl groups may be linked to each other through divalent groups —C(R⁵¹)(R⁵²)— and/or —C(R⁶¹)═C(R⁶²)—. R⁵¹, R⁵², R⁶¹, and R⁶² are each independently a hydrogen atom or a C1-C3 alkyl group.

The groups in formula (C1) may be substituted by a halogen atom, a C1-C5 alkyl group, a C1-C5 alkoxy group, or a substituted amino group substituted by a C1-C3 alkyl group.

From the viewpoint of charge mobility, the compound (C1) is preferably a compound having at least one of an aryl group or —C6H4-CH═CH—CH═C(R^{T7})(R^{T8}), more preferably a compound (C′1) represented by formula (C′1).

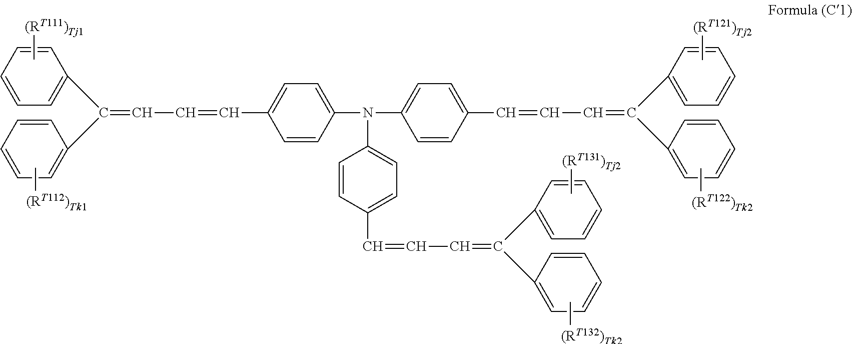

In formula (C′1), R^{T111}, R^{T112}, R^{T121}, R^{T122}, R^{T131}, and R^{T132} are each independently a hydrogen atom, a halogen atom, an alkyl group (e.g., C1-C3 alkyl group), an alkoxy group (e.g., C1-C3 alkoxy group), a phenyl group, or a phenoxy group. Tj1, Tj2, Tj3, Tk1, Tk2, and Tk3 are each independently 0, 1, or 2.

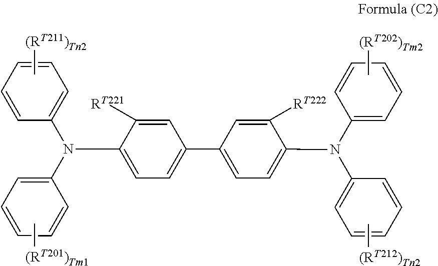

In formula (C2), R^{T201}, R^{T202}, R^{T211}, and R^{T212} are each independently a halogen atom, a C1-C5 alkyl group, a C1-C5 alkoxy group, an amino group substituted by a C1-C2 alkyl group, an aryl group, —C(R^{T21})═C(R^{T22})(R^{T23}), or —CH═CH—CH═C(R^{T24})(R^{T25}). R^{T21}, R^{T22}, R^{T23}, R^{T24}, and R^{T25} are each independently a hydrogen atom, an alkyl group, or an aryl group. R^{T221} and R^{T222} are each independently a hydrogen atom, a halogen atom, a C1-C5 alkyl group, or a C1-C5 alkoxy group. Tm1, Tm2, Tn1, and Tn2 are each independently 0, 1, or 2.

The groups in formula (C2) may be substituted by a halogen atom, a C1-C5 alkyl group, a C1-C5 alkoxy group, or a substituted amino group substituted by a C1-C3 alkyl group. From the viewpoint of charge mobility, the compound (C2) is preferably a compound having at least one of an alkyl group, an aryl group, or —CH═CH—CH═C(R^{T24})(R^{T25}), more preferably a compound having two of an alkyl group, an aryl group, or —CH═CH—CH═C(R^{T24})(R^{T25}).

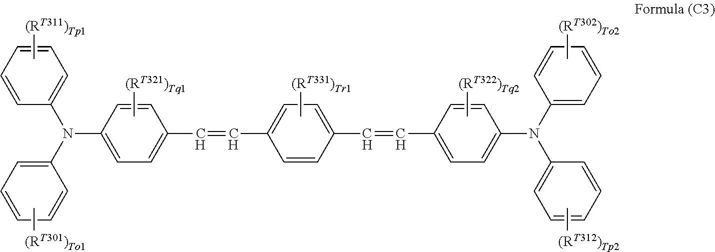

In formula (C3), R^{T301}, R^{T302}, R^{T311}, and R^{T312} are each independently a halogen atom, a C1-C5 alkyl group, a C1-C5 alkoxy group, an amino group substituted by a C1-C2 alkyl group, an aryl group, —C(R^{T31})—C(R^{T32})(R^{T33}), or —CH═CH—CH═C(R^{T34})(R^{T35}). R^{T31}, R^{T32}, R^{T33}, R^{T34}, and R^{T35} are each independently a hydrogen atom, an alkyl group, or an aryl group. R^{T321}, R^{T322}, and R^{T331} are each independently a hydrogen atom, a halogen atom, a C1-C5 alkyl group, or a C1-C5 alkoxy group. To1, To2, Tp1, Tp2, Tq1, Tq2, and Tr1 are each independently 0, 1, or 2.

The groups in formula (C3) may be substituted by a halogen atom, a C1-C5 alkyl group, a C1-C5 alkoxy group, or a substituted amino group substituted by a C1-C3 alkyl group.

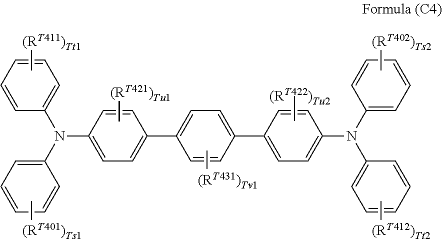

In formula (C4), R^{T401}, R^{T402}, R^{T411}, and R^{T412} are each independently a halogen atom, a C1-C5 alkyl group, a C1-C5 alkoxy group, an amino group substituted by a C1-C2 alkyl group, an aryl group, —C(R^{T41})═C(R^{T42})(R^{T43}), or —CH═CH—CH═C(R^{T44})(R^{T45}). R^{T41}, R^{T42}, R^{T43}, R^{T44}, and R^{T45} are each independently a hydrogen atom, an alkyl group, or an aryl group. R^{T421}, R^{T422}, and R^{T431} are each independently a hydrogen atom, a halogen atom, a C1-C5 alkyl group, or a C1-C5 alkoxy group. Ts1, Ts2, Tt1, Tt2, Tu1, Tu2, and Tv1 are each independently 0, 1, or 2.

The groups in formula (C4) may be substituted by a halogen atom, a C1-C5 alkyl group, a C1-C5 alkoxy group, or a substituted amino group substituted by a C1-C3 alkyl group.

The amount of the charge-transporting material contained in the charge transport layer is preferably 20 mass % or more and 70 mass % or less, more preferably 25 mass % or more and 65 mass % or less, still more preferably 30 mass % or more and 60 mass % or less, relative to the total mass of the charge transport layer.

The charge transport layer contains at least the polyester resin (1) as a binder resin. The proportion of the polyester resin (1) relative to the total amount of the binder resin contained in the charge transport layer is preferably 30 mass % or more, more preferably 40 mass % or more, still more preferably 50 mass % or more, yet still more preferably 55 mass % or more. When the polyester resin (1) is used in combination with another resin, a polycarbonate resin may be used as another resin.

The charge transport layer may contain another binder resin other than the polyester resin (1). Examples of another binder resin include polyester resins other than the polyester resin (1), polycarbonate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. These binder resins are used singly or in combination of two or more.

The charge transport layer may contain other known additives. Examples of the additives include antioxidants, leveling agents, anti-foaming agents, fillers, and viscosity modifiers.

The charge transport layer may be formed by any of known forming methods. For example, a coating liquid for forming the charge transport layer is prepared by adding the above components to a solvent, and a coating film of the coating liquid is formed, dried, and heated as needed.

Examples of the solvent used for preparing the coating liquid for forming the charge transport layer include aromatic hydrocarbons, such as benzene, toluene, xylene, and chlorobenzene; ketones, such as acetone and 2-butanone; halogenated aliphatic hydrocarbons, such as methylene chloride, chloroform, and ethylene chloride; and ordinary organic solvents, such as cyclic or linear ethers, such as tetrahydrofuran and ethyl ether. These solvents are used singly or as a mixture of two or more.

Examples of the application method for applying the coating liquid for forming the charge transport layer onto the charge generation layer include common methods, such as a blade coating method, a wire bar coating method, a spray coating method, a dip coating method, a bead coating method, an air knife coating method, and a curtain coating method.

The film thickness of the charge transport layer is, for example, 5 μm or more and 50 μm or less. From the viewpoint of the photosensitivity and wear life of the photoreceptor, the film thickness of the charge transport layer is preferably 20 μm or more, more preferably 22 μm or more, still more preferably 25 μm or more. From the viewpoint of residual potential, the film thickness of the charge transport layer is preferably 50 μm or less, more preferably 47 μm or less, still more preferably 45 μm or less.

### Single Layer Type Photosensitive Layer

The single layer type photosensitive layer (charge generation/charge transport layer) is a layer containing a charge-generating material, a charge-transporting material, a binder resin, and other optional additives. These materials are the same as the materials described for the charge generation layer and the charge transport layer.

The single layer type photosensitive layer contains at least the polyester resin (1) as a binder resin. The proportion of the polyester resin (1) relative to the total amount of the binder resin contained in the single layer type photosensitive layer is preferably 30 mass % or more, more preferably 40 mass % or more, still more preferably 50 mass % or more, yet still more preferably 55 mass % or more. When the polyester resin (1) is used in combination with another resin, a polycarbonate resin may be used as another resin.

The amount of the charge-generating material in the single layer type photosensitive layer may be 0.1 mass % or more and 10 mass % or less, preferably 0.8 mass % or more and 5 mass % or less, relative to the total mass of the single layer type photosensitive layer.

The amount of the charge-transporting material contained in the single layer type photosensitive layer is preferably 25 mass % or more and 70 mass % or less, more preferably 30 mass % or more and 65 mass % or less, still more preferably 40 mass % or more and 60 mass % or less, relative to the total mass of the single layer type photosensitive layer.

The single layer type photosensitive layer is formed by the same method as the method for forming the charge generation layer or the charge transport layer.

The film thickness of the single layer type photosensitive layer is, for example, 5 μm or more and 50 μm or less. From the viewpoint of the photosensitivity and wear life of the photoreceptor, the film thickness of the single layer type photosensitive layer is preferably 10 μm or more, more preferably 12 μm or more, still more preferably 15 μm or more. From the viewpoint of residual potential, the film thickness of the single layer type photosensitive layer is preferably 50 μm or less, more preferably 47 μm or less, still more preferably 45 μm or less, yet still more preferably 40 μm or less.

### Protective Layer

The protective layer is disposed on the photosensitive layer as needed. The protective layer is disposed for the purpose of, for example, preventing chemical changes of the photosensitive layer during charging or further improving the mechanical strength of the photosensitive layer.

For this, the protective layer may be composed of a cured film (cross-linked film). Examples of the cured film include layers described below in 1) or 2).
1) A layer composed of a cured film with a composition containing a reactive group-containing charge-transporting material having a reactive group and a charge transportable skeleton in the same molecule (i.e., a layer containing a polymer or cross-linked product of the reactive group-containing charge-transporting material)
2) A layer composed of a cured film with a composition containing a non-reactive charge-transporting material and a reactive group-containing non-charge-transporting material having a reactive group but not having a charge transportable skeleton (i.e., a layer containing the non-reactive charge-transporting material and a polymer or cross-linked product of the reactive group-containing non-charge-transporting material)

Examples of the reactive group of the reactive group-containing charge-transporting material include known reactive groups, such as chain polymerizable groups, an epoxy group, —OH, —OR [wherein R represents an alkyl group], —NH₂, —SH, —COOH, and —SiR^{Q1}_{3-Qn}(OR^{Q2})_{Qn} [wherein R^{Q1} represents a hydrogen atom, an alkyl group, or a substituted or unsubstituted aryl group, and R^{Q2} represents a hydrogen atom, an alkyl group, or a trialkylsilyl group. Qₙ represents an integer of 1 to 3].

The chain polymerizable groups are any functional groups that may undergo radical polymerization and are, for example, functional groups having at least a carbon double bond. Specific examples of the chain polymerizable groups include groups containing at least one selected from vinyl groups, vinyl ether groups, vinyl thioether groups, phenyl vinyl groups, vinyl phenyl groups, acryloyl groups, methacryloyl groups, and derivatives thereof. The chain polymerizable groups may contain at least one selected from vinyl groups, phenyl vinyl groups, vinyl phenyl groups, acryloyl groups, methacryloyl groups, and derivatives thereof due to their high reactivity.

The charge transportable skeleton of the reactive group-containing charge-transporting material may have any structure known in the electrophotographic photoreceptor. Examples of the charge transportable skeleton include skeletons that are derived from nitrogen-containing hole-transporting compounds, such as triarylamine compounds, benzidine compounds, and hydrazone compounds, and that have structures conjugated with nitrogen atoms. The charge transportable skeleton may be a triarylamine skeleton among these.

The reactive group-containing charge-transporting material having a reactive group and a charge transportable skeleton, the non-reactive charge-transporting material, and the reactive group-containing non-charge-transporting material are selected from known materials.

The protective layer may contain other known additives.

The protective layer may be formed by any of known forming methods. For example, a coating liquid for forming the protective layer is prepared by adding the above components to a solvent, and a coating film of the coating liquid is formed, dried, and cured by heating or other processes as needed.

Examples of the solvent used for preparing the coating liquid for forming the protective layer include aromatic solvents, such as toluene and xylene; ketone solvents, such as methyl ethyl ketone, methyl isobutyl ketone, and cyclohexanone; ester solvents, such as ethyl acetate and butyl acetate; ether solvents, such as tetrahydrofuran and dioxane; cellosolve solvents, such as ethylene glycol monomethyl ether; and alcohol solvents, such as isopropyl alcohol and butanol. These solvents are used singly or as a mixture of two or more.

The coating liquid for forming the protective layer may be a solvent-free coating liquid.

Examples of the method for applying the coating liquid for forming the protective layer onto the photosensitive layer (e.g., charge transport layer) include common methods, such as a dip coating method, a lift coating method, a wire bar coating method, a spray coating method, a blade coating method, an air knife coating method, and a curtain coating method.

The film thickness of the protective layer is preferably set, for example, in the range of 1 μm or more and 20 μm or less, more preferably in the range of 2 μm or more and 10 μm or less.

### Image Forming Apparatus, Process Cartridge

An image forming apparatus according to the present exemplary embodiment includes: an electrophotographic photoreceptor; a charging device that charges the surface of the electrophotographic photoreceptor; an electrostatic latent image-forming device that forms an electrostatic charge image on the charged surface of the electrophotographic photoreceptor; a developing device that develops the electrostatic latent image on the surface of the electrophotographic photoreceptor by using a developer containing a toner to form a toner image; and a transfer device that transfers the toner image to the surface of a recording medium. The electrophotographic photoreceptor according to the present exemplary embodiment is used as an electrophotographic photoreceptor.

The image forming apparatus according to the present exemplary embodiment may be a known image forming apparatus, such as an apparatus including a fixing device that fixes a toner image that has been transferred to the surface of a recording medium; a direct transfer-type apparatus in which a toner image formed on the surface of an electrophotographic photoreceptor is directly transferred to a recording medium; an intermediate transfer-type apparatus in which a toner image formed on the surface of an electrophotographic photoreceptor is first transferred to the surface of an intermediate transfer body, and the toner image, which has been transferred to the surface of the intermediate transfer body, is second transferred to the surface of a recording medium; an apparatus including a cleaning device that cleans the surface of an electrophotographic photoreceptor before charging after transfer of a toner image; an apparatus including a discharging device that discharges the surface of an electrophotographic photoreceptor by irradiating the surface of the electrophotographic photoreceptor with discharging light before charging after transfer of a toner image; and an apparatus including an electrophotographic photoreceptor-heating member for increasing the temperature of an electrophotographic photoreceptor to reduce the relative temperature.

In an intermediate transfer-type apparatus, the transfer device includes, for example, an intermediate transfer body having the surface to which a toner image is transferred, a first transfer device that first transfers the toner image on the surface of the electrophotographic photoreceptor to the surface of the intermediate transfer body, and a second transfer device that second transfers the toner image, which has been transferred to the surface of the intermediate transfer body, to the surface of a recording medium.

The image forming apparatus according to the present exemplary embodiment may be either a dry development-type image forming apparatus or a wet development-type (development type using a liquid developer) image forming apparatus.

In the image forming apparatus according to the present exemplary embodiment, for example, a section including the electrophotographic photoreceptor may have a cartridge structure (process cartridge) that is attachable to and detachable from the image forming apparatus. The process cartridge may be, for example, a process cartridge including the electrophotographic photoreceptor according to the present exemplary embodiment. The process cartridge may include, for example, at least one selected from the group consisting of a charging device, an electrostatic latent image-forming device, a developing device, and a transfer device, in addition to the electrophotographic photoreceptor.

An example of the image forming apparatus according to the present exemplary embodiment will be described below, but the image forming apparatus is not limited to this example. The main parts shown in the figures will be described, and other parts will not be described.

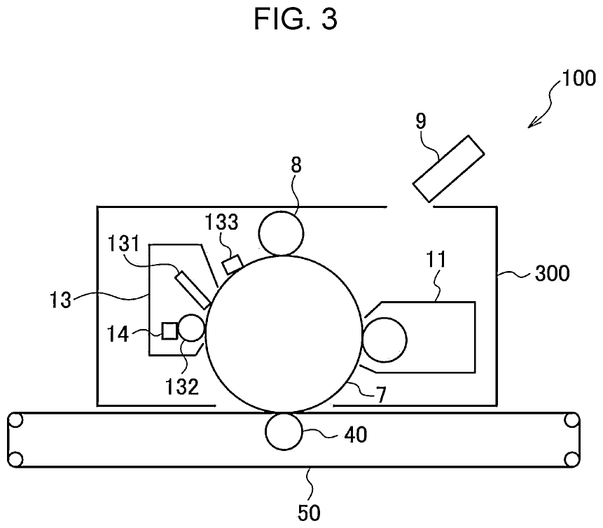

FIG. 3 is a schematic structural view of one example of the image forming apparatus according to the present exemplary embodiment.

Referring to FIG. 3, an image forming apparatus 100 according to the present exemplary embodiment includes a process cartridge 300 including an electrophotographic photoreceptor 7, an exposure device 9 (example electrostatic latent image-forming device), a transfer device 40 (first transfer device), and an intermediate transfer body 50. In the image forming apparatus 100, the exposure device 9 is positioned so as to expose the electrophotographic photoreceptor 7 to light from an opening of the process cartridge 300, the transfer device 40 is positioned so as to face the electrophotographic photoreceptor 7 with the intermediate transfer body 50 between the transfer device 40 and the electrophotographic photoreceptor 7, and the intermediate transfer body 50 is positioned such that part of the intermediate transfer body 50 is in contact with the electrophotographic photoreceptor 7. Although not shown, the image forming apparatus 100 further includes a second transfer device that transfers, to a recording medium (e.g., paper), a toner image that has been transferred to the intermediate transfer body 50. The intermediate transfer body 50, the transfer device 40 (first transfer device), and the second transfer device (not shown) correspond to examples of the transfer device.

The process cartridge 300 in FIG. 3 integrally supports, in a housing, the electrophotographic photoreceptor 7, a charging device 8 (example charging device), a developing device 11 (example developing device), and a cleaning device 13 (example cleaning device). The cleaning device 13 has a cleaning blade (example cleaning member) 131, and the cleaning blade 131 is disposed in contact with the surface of the electrophotographic photoreceptor 7. The cleaning member may be a conductive or insulating fibrous member, instead of the cleaning blade 131. The conductive or insulating fibrous member may be used singly or in combination with the cleaning blade 131.

FIG. 3 illustrates the image forming apparatus including a fibrous member 132 (roll shape) that supplies a lubricant 14 to the surface of the electrophotographic photoreceptor 7 and a fibrous member 133 (flat brush shape) that assists cleaning. These members are disposed as needed.

Each component of the image forming apparatus according to the present exemplary embodiment will be described below.

### Charging Device

Examples of the charging device 8 include contact-type chargers using, for example, a conductive or semi-conductive charging roller, a charging brush, a charging film, a charging rubber blade, and a charging tube. Examples of the charging device 8 also include chargers known per se, such as contactless roller chargers, and scorotron chargers and corotron chargers using corona discharge.

### Exposure Device

Examples of the exposure device 9 include an optical device that exposes the surface of the electrophotographic photoreceptor 7 to light, such as semiconductor laser light, LED light, or liquid crystal shutter light, in a predetermined image pattern. The light source has a wavelength in the region of the spectral sensitivity of the electrophotographic photoreceptor. Semiconductor lasers that are mainly used are near-infrared lasers having an oscillation wavelength of about 780 nm. However, the wavelength is not limited to this, and a laser having an oscillation wavelength in the 600 nm range or a blue laser having an oscillation wavelength of 400 nm or more and 450 nm or less may also be used. A surface-emitting laser light source that may output multiple beams is also effectively used to form color images.

### Developing Device

The developing device 11 is, for example, a typical developing device that performs development using a developer in a contact or non-contact manner. The developing device 11 is not limited as long as the developing device 11 has the function described above, and the developing device 11 is selected according to the purpose. Examples of the developing device 11 include known developing units having a function of attaching a one-component developer or two-component developer to the electrophotographic photoreceptor 7 with a brush, a roller, or other tools. The developing device 11 may use a developing roller that holds a developer on its surface.

The developer used in the developing device 11 may be a one-component developer containing only a toner, or may be a two-component developer containing a toner and a carrier. The developer may be magnetic or non-magnetic. The developer is a known one.

### Cleaning Device

The cleaning device 13 is a cleaning blade-type device including the cleaning blade 131. The cleaning device 13 may be a fur brush cleaning-type device or simultaneous development cleaning-type device instead of a cleaning blade-type device.

### Transfer Device

Examples of the transfer device 40 include contact-type transfer chargers using a belt, a roller, a film, a rubber blade, or the like; and transfer chargers known per se, such as scorotron transfer chargers and corotron transfer chargers using corona discharge.

### Intermediate Transfer Body

The intermediate transfer body 50 may have a belt shape (intermediate transfer belt) containing polyimide, polyamideimide, polycarbonate, polyarylate, polyester, rubber, or the like provided with semiconductivity. The intermediate transfer body may have a drum shape instead of a belt shape.

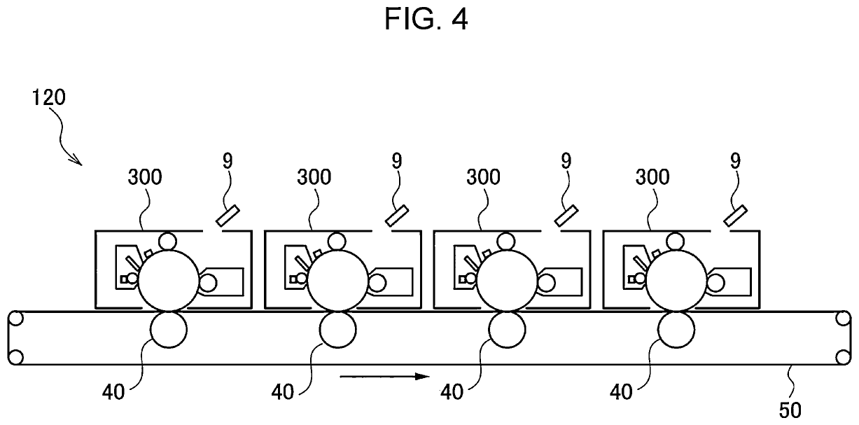

FIG. 4 is a schematic structural view of another example of the image forming apparatus according to the present exemplary embodiment.

An image forming apparatus 120 in FIG. 4 is a tandem-system multicolor image forming apparatus including four process cartridges 300. In the image forming apparatus 120, the four process cartridges 300 are arranged in parallel on an intermediate transfer body 50, and one electrophotographic photoreceptor is used for one color. The image forming apparatus 120 has the same structure as the image forming apparatus 100 except for the tandem system.

### EXAMPLES

Exemplary embodiments of the present disclosure will be described below in detail by way of Examples, but exemplary embodiments of the present disclosure are not limited to these Examples.

In the following description, the units “part” and “%” are on a mass basis, unless otherwise specified.

In the following description, synthesis, treatment, production, and other processes are carried out at room temperature (25° C.±3° C.), unless otherwise specified.

### Preparation of Polyester Resin

In Examples and Comparative Examples shown in Table 1 and Table 2, at least two types of polyester resins that have the same types of structural units but have different weight average molecular weights are synthesized and mixed to prepare polyester resins of Examples. In synthesis of all polyester resins, polymerization is performed in the presence of terminal capping agent 2,3,5-trimethylphenol so that the resin terminals are capped with the terminal capping agent.

In Comparative Example S1 and Comparative Example T1, one type of monodispersed polyester resin is used.

Table 1 and Table 2 show the units constituting polyester resins.

In Table 1 and Table 2, A2-3 and the like are specific examples of the dicarboxylic acid unit (A) described above.

In Table 1 and Table 2, B1-4 and the like are specific examples of the diol unit (B) described above.

In Example S13, two types of dicarboxylic acid units (A) are used to synthesize the polyester resin, and the molar ratio of two types of dicarboxylic acid units (A) is (A1-1):(A1-7)=1:1.

In Example S22, two types of diol units (B) are used to synthesize the polyester resin, and the molar ratio of two types of diol units (B) is (B1-2):(B7-2)=2:3.

In Example S23, two types of dicarboxylic acid units (A) are used to synthesize the polyester resin, and the molar ratio of two types of dicarboxylic acid units (A) is (A3-2):(A4-3)=4:1.

### Production of Photoreceptor Including Multilayer-Type Photosensitive Layer

### Example S1

### Formation of Undercoat Layer

A cylindrical aluminum tube with an outer diameter of 30 mm, a length of 365 mm, and a wall thickness of 1.6 mm is prepared as a conductive substrate.

Zinc oxide (100 parts) (average particle size: 70 nm, specific surface area: 15 m²/g, available from TAYCA CORPORATION) is mixed with 500 parts of toluene under stirring, and 1.3 parts of a silane coupling agent (N-2-(aminoethyl)-3-aminopropyltrimethoxysilane, product name: KBM-603, available from Shin-Etsu Chemical Co., Ltd.,) is added and stirred for two hours. Subsequently, toluene is distilled off under reduced pressure, and baking is performed at 120° C. for three hours to obtain zinc oxide having a surface treated with the silane coupling agent.

The surface-treated zinc oxide (110 parts) is mixed with 500 parts of tetrahydrofuran under stirring, and a solution of 0.6 parts of alizarin in 50 parts of tetrahydrofuran is added. The resulting mixture is stirred at 50° C. for five hours. Subsequently, the solids of the mixture are separated by filtering under reduced pressure and dried at 60° C. under reduced pressure to obtain alizarin-added zinc oxide.

A solution is prepared by dissolving 60 parts of alizarin-added zinc oxide, 13.5 parts of a curing agent (blocked isocyanate, product name: Sumidur 3175, available from Sumika Bayer Urethane Co. Ltd.), and 15 parts of a butyral resin (product name: S-LEC BM-1, available from Sekisui Chemical Co., Ltd.) in 68 parts of methyl ethyl ketone, and 100 parts of the solution is mixed with 5 parts of methyl ethyl ketone. The resulting mixture is dispersed for two hours in a sand mill using glass beads having a diameter of 1 mm to obtain a dispersion. To the dispersion, 0.005 parts of dioctyltin dilaurate serving as a catalyst and 4 parts of silicone resin particles (product name: Tospearl 145, available from Momentive Performance Materials Japan LLC) are added to obtain a coating liquid for forming an undercoat layer. The coating liquid for forming the undercoat layer is applied to the outer circumferential surface of a conductive substrate by dip coating and cured by drying at 185° C. for 35 minutes to form an undercoat layer having an average thickness of 25 μm.

### Formation of Charge Generation Layer

A mixture composed of 15 parts of hydroxygallium phthalocyanine (with diffraction peaks at least at Bragg's angles (2θ+0.2°) of 7.5°, 9.9°, 12.5°, 16.3°, 18.6°, 25.1°, and 28.3° in an X-ray diffraction spectrum using CuKα characteristic X-rays) serving as a charge generating substance, 10 parts of a vinyl chloride/vinyl acetate copolymer resin (product name: VMCH, available from Nippon Unicar Company Limited) serving as a binder resin, and 200 parts of n-butyl acetate is dispersed for four hours in a sand mill using glass beads having a diameter of 1 mm. To the dispersion, 175 parts of n-butyl acetate and 180 parts of methyl ethyl ketone are added. The resulting mixture is stirred to obtain a coating liquid for forming the charge generation layer. The coating liquid for forming the charge generation layer is applied onto the undercoat layer by dip coating and dried at room temperature (25° C.±3° C.) to form a charge generation layer having an average thickness of 0.25 μm.

### Formation of Charge Transport Layer

Binder resin: polyester resin 60 parts
Charge-transporting material: CTM-1 40 parts
Tetrahydrofuran 270 parts
Toluene 30 parts

The structural units, weight average molecular weight, and molecular weight distribution of the polyester resins used in these Examples are described in Table 1.

The materials described above are mixed under stirring to obtain a coating liquid for forming a charge transport layer. The coating liquid for forming a charge transport layer is applied onto the charge generation layer by dip coating and dried at 145° C. for 30 minutes to form a charge transport layer having an average thickness of 40 μm.

### Examples S2 to S24 and Comparative Examples S1 to S5

Photoreceptors are produced in the same manner as in Example S1 except that the type of binder resin in the charge transport layer is changed as described in Table 1.

### Example S25

A photoreceptor is produced in the same manner as in Example S1 except that the binder resin in the charge transport layer is changed to 30 parts of the polyester resin and 30 parts of the polycarbonate resin. The structural units, weight average molecular weight, and molecular weight distribution of the polyester resin used in this Example are described in Table 1.

The polycarbonate resin used in this Example is the polycarbonate resin composed of repeating units described below. This resin is referred to as a polycarbonate resin (PC-1).

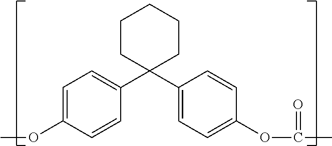

### Examples S26 to S29

Photoreceptors are produced in the same manner as in Example S1 except that the type of binder resin and the type of charge-transporting material in the charge transport layer are changed as described in Table 1.

In Example 28, 20 parts of CTM-1 and 20 parts of CTM-3 are used.

The chemical structures of charge-transporting materials CTM-1 to CTM-4 are shown below.

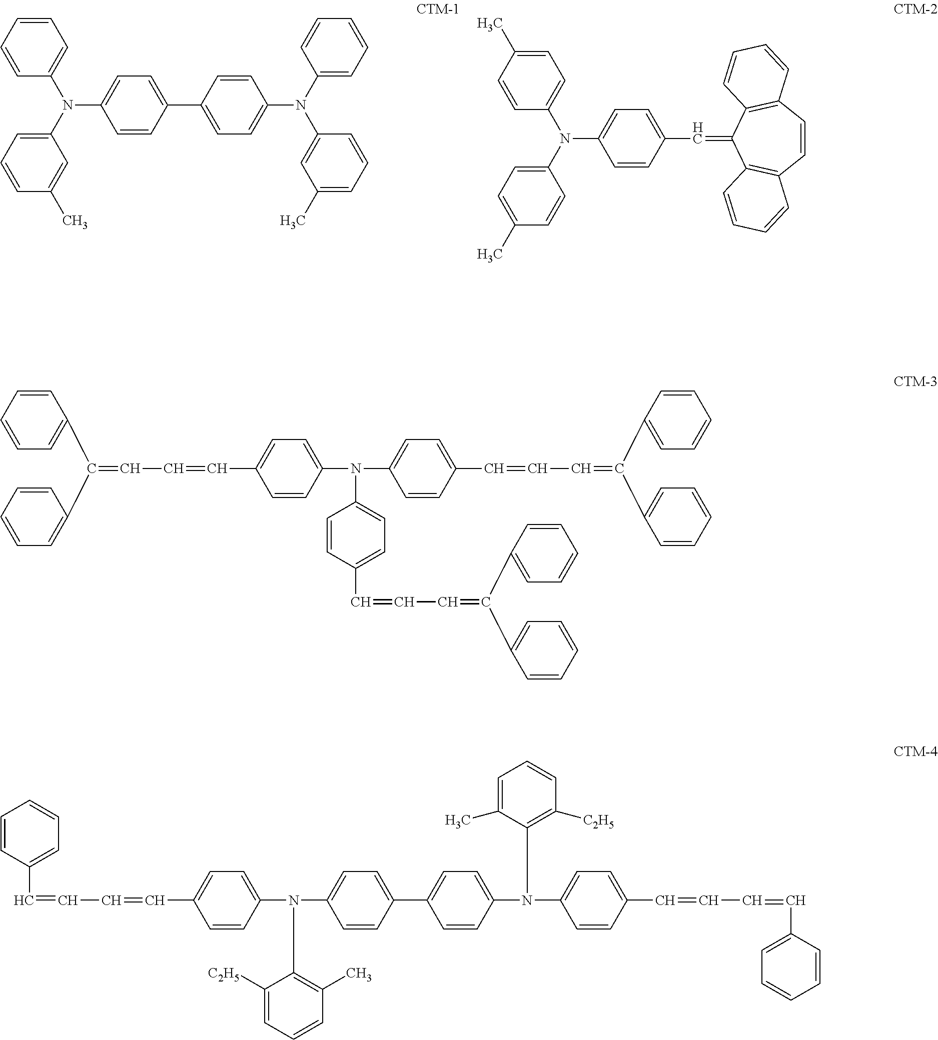 [SMILES: Cc1cccc(N(c2ccccc2)c2ccc(-c3ccc(N(c4ccccc4)c4cccc(C)c4)cc3)cc2)c1 ; Cc1ccc(N(c2ccc(C)cc2)c2ccc(C=C3c4ccccc4C=Cc4ccccc43)cc2)cc1 ; C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1 ; CCc1cccc(C)c1N(c1ccc(C=CC=Cc2ccccc2)cc1)c1ccc(-c2ccc(N(c3ccc(C=CC=Cc4ccccc4)cc3)c3c(C)cccc3CC)cc2)cc1]

### Production of Photoreceptor Including Single Layer Type Photosensitive Layer

### Example T1

### Formation of Undercoat Layer

A cylindrical aluminum tube with an outer diameter of 30 mm, a length of 365 mm, and a wall thickness of 1.6 mm is prepared as a conductive substrate.

Zinc oxide (100 parts) (average particle size: 70 nm, specific surface area: 15 m²/g, available from TAYCA CORPORATION) is mixed with 500 parts of toluene under stirring, and 1.3 parts of a silane coupling agent (N-2-(aminoethyl)-3-aminopropyltrimethoxysilane, product name: KBM-603, available from Shin-Etsu Chemical Co., Ltd.,) is added and stirred for two hours. Subsequently, toluene is distilled off under reduced pressure, and baking is performed at 120° C. for three hours to obtain zinc oxide having a surface treated with the silane coupling agent.

The surface-treated zinc oxide (110 parts) is mixed with 500 parts of tetrahydrofuran under stirring, and a solution of 0.6 parts of alizarin in 50 parts of tetrahydrofuran is added. The resulting mixture is stirred at 50° C. for five hours. Subsequently, the solids of the mixture are separated by filtering under reduced pressure and dried at 60° C. under reduced pressure to obtain alizarin-added zinc oxide.

A solution is prepared by dissolving 60 parts of alizarin-added zinc oxide, 13.5 parts of a curing agent (blocked isocyanate, product name: Sumidur 3175, available from Sumika Bayer Urethane Co. Ltd.), and 15 parts of a butyral resin (product name: S-LEC BM-1, available from Sekisui Chemical Co., Ltd.) in 68 parts of methyl ethyl ketone, and 100 parts of the solution is mixed with 5 parts of methyl ethyl ketone. The resulting mixture is dispersed for two hours in a sand mill using glass beads having a diameter of 1 mm to obtain a dispersion. To the dispersion, 0.005 parts of dioctyltin dilaurate serving as a catalyst and 4 parts of silicone resin particles (product name: Tospearl 145, available from Momentive Performance Materials Japan LLC) are added to obtain a coating liquid for forming an undercoat layer. The coating liquid for forming the undercoat layer is applied to the outer circumferential surface of the conductive substrate by dip coating and cured by drying at 185° C. for 35 minutes to form an undercoat layer having an average thickness of 25 μm.

Formation of Single layer type Photosensitive Layer
Binder resin: polyester resin 52.75 parts
Charge-generating material: hydroxygallium phthalocyanine Type V 1.25 parts
(with diffraction peaks at least at Bragg's angles (2θ+0.2°) of 7.3°, 16.0°, 24.9°, and 28.0° in an X-ray diffraction spectrum using CuKα characteristic X-rays)
Charge-transporting material: ETM-1 7.8 parts
Charge-transporting material: CTM-1 38.2 parts
(mass ratio of ETM-1 to CTM-1:17:83)
Tetrahydrofuran 175 parts
Toluene 75 parts

The structural units, weight average molecular weight, and molecular weight distribution of the polyester resin used in this Example are described in Table 2.

The materials described above are mixed and subjected to a dispersion treatment for four hours in a sand mill using glass beads with a diameter of 1 mm to obtain a coating liquid for forming a photosensitive layer. The coating liquid for forming a photosensitive layer is applied onto the undercoat layer by dip coating and cured by drying at a temperature of 110° C. for 40 minutes to form a single layer type photosensitive layer having an average thickness of 34 μm.

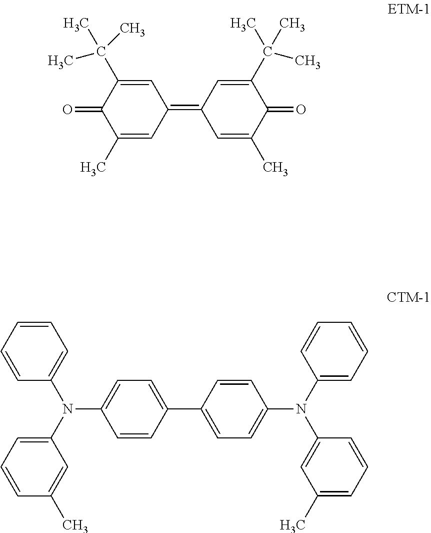 [SMILES: CC1=C/C(=C2\C=C(C)C(=O)C(C(C)(C)C)=C2)C=C(C(C)(C)C)C1=O ; Cc1cccc(N(c2ccccc2)c2ccc(-c3ccc(N(c4ccccc4)c4cccc(C)c4)cc3)cc2)c1]

### Examples T2 to T11, T13, and T14, and Comparative Examples T1 to T5

Photoreceptors are produced in the same manner as in Example T1 except that the type of binder resin in the single layer type photosensitive layer is changed to the types described in Table 2.

### Example T12

A photoreceptor is produced in the same manner as in Example T1 except that the binder resin in the single layer type photosensitive layer is changed to 26.75 parts of the polyester resin and 26 parts of a polycarbonate resin. The structural units, weight average molecular weight, and molecular weight distribution of the polyester resin used in this Example are described in Table 2. The polycarbonate resin used in this Example is the polycarbonate resin (PC-1).

### Photoreceptor Performance Evaluation

### Potential Distribution

The photoreceptor of each of Examples and Comparative Examples is installed into image forming apparatus Apeos C7070 (FUJIFILM Business Innovation Corp). To measure the surface potential of the photoreceptor, a probe connected to a surface potential meter (TREK 334, TREK Japan) is placed 1 mm away from the photoreceptor surface at the center of the photoreceptor in the axial direction. The charging conditions and the exposure conditions are adjusted such that the surface potential after charging becomes-650 V and the surface potential after exposure becomes-300 V in an environment with a temperature of 20° C. and a relative humidity of 40%.

The probe connected to the surface potential meter is placed at 11 positions in total: at the center of the photoreceptor in the axial direction and at positions of 2 cm, 4 cm, 6 cm, 8 cm, and 10 cm from the center toward the opposite ends in the axial direction. The surface potential of the photoreceptor is measured at these 11 positions, and a difference between the maximum value and the minimum value is calculated and classified as described below.
A+: The difference is 5 V or less.
A: The difference is more than 5 V and 10 V or less.
B: The difference is more than 10 V and 20 V or less.
C: The difference is more than 20 V.

### Image Quality After Dropping

### Normal Environment

The following operation is carried out in an environment with a temperature of 20° C. and a relative humidity of 40%.

The photoreceptor in each of Examples and Comparative Examples is combined with other members to produce a process cartridge 300 shown in FIG. 3. To record the position of contact between the photoreceptor and the cleaning blade, the points of contact on the opposite ends of the photoreceptor in the axial direction are marked with an oil-based ink. The position of contact can be identified because, in image formation, the area on the photoreceptor surface marked with the oil-based ink differs from an area without marks with the oil-based ink in the amount of toner deposition.

Next, the process cartridge is allowed to freely fall onto a horizontal concrete stage from a height of 30 cm with the axial direction of the photoreceptor in the horizontal direction. This free fall is carried out four times in total, with the photoreceptor being rotated 90° in the circumferential direction between each fall (i.e., the position of contact between the photoreceptor and the cleaning blade being shifted 90° in the circumferential direction between each fall).

Next, the process cartridge is installed into image forming apparatus Apeos C7070, and a black image with an area coverage of 30% is continuously output on ten sheets of A3 plain paper.

The images on ten sheets are visually observed. The positions corresponding to the areas where the photoreceptor has been in contact with the cleaning blade in the free fall of the process cartridge are compared with other positions to visually check whether there are differences in color density and image defects. The presence of differences in color density and image defects is classified as described below.
A+: No image defects are observed, nor are any differences in color density.
A: No image defects are observed. Small differences in color density are observed but disappear within 10 sheets.
B: Minor image defects are observed in some areas in the axial direction.
C: Noticeable image defects are observed in the entire area in the axial direction.

### High Temperature and High Humidity

The photoreceptor in each of Examples and Comparative Examples is combined with other members to produce a process cartridge 300 shown in FIG. 3, and marks are made with an oil-based ink in the same manner as described above. The process cartridge is then left to stand in an environment with a temperature of 40° C. and a relative humidity of 85% for three days.

Next, the same free fall test as described above is carried out in an environment with a temperature of 40° C. and a relative humidity of 85%.

Next, the process cartridge is left to stand in an environment with a temperature of 20° C. and a relative humidity of 40% for 10 hours, and the same image forming test as described above is carried out in an environment with a temperature of 20° C. and a relative humidity of 40%.

### Storage Stability

### Normal Environment

The following operation is carried out in an environment with a temperature of 20° C. and a relative humidity of 40%.

The photoreceptor in each of Examples and Comparative Examples is combined with other members to produce a process cartridge 300 shown in FIG. 3. A urethane sponge (1 cm square) (3M Scotch-Brite is formed into a 1-cm square cube) is sandwiched in an area of contact between the cleaning blade and a central portion of the photoreceptor in the axial direction, and the cleaning blade contact points on the opposite ends of the photoreceptor in the axial direction are marked with an oil-based ink in order to record the position of contact. The position of contact can be identified because, in image formation, the area on the photoreceptor surface marked with the oil-based ink differs from an area without marks with the oil-based ink in the amount of toner deposition.

Next, the process cartridge is left to stand in an environment with a temperature of 20° C. and a relative humidity of 40% for three days with the urethane sponge between the cleaning blade and the photoreceptor.

Next, the urethane sponge is removed from the process cartridge, and the process cartridge is installed into image forming apparatus Apeos C7070. A black image with an area coverage of 30% is continuously output on ten sheets of A3 plain paper.

The images on ten sheets are visually observed. The position corresponding to the urethane sponge contact area during storage for three days is compared with the other positions to visually observe differences in color density and image defects. The presence of differences in color density and image defects is classified as described below.
A+: No image defects are observed, nor are any differences in color density.
A: No image defects are observed. Small differences in color density are observed but disappear within 10 sheets.
B: Minor image defects are observed in some areas in the axial direction.
C: Noticeable image defects are observed in the entire area in the axial direction.

### High Temperature and High Humidity

The photoreceptor in each of Examples and Comparative Examples is combined with other members to produce a process cartridge 300 shown in FIG. 3, and a urethane sponge is sandwiched in the same manner as described above. The process cartridge is then left to stand in an environment with a temperature of 40° C. and a relative humidity of 85% for three days.

Next, the urethane sponge is removed from the process cartridge, and the process cartridge is left to stand in an environment with a temperature of 20° C. and a relative humidity of 40% for 10 hours. The same image forming test as described above is carried out in an environment with a temperature of 20° C. and a relative humidity of 40%.

TABLE 1

| | | | | | | | | | Performance of Photoreceptor | | | | |
|---|---|---|---|---|---|---|---|---|---|---|---|---|---|
| | | | | | | | | | | Image After Fall | | Storage Stability | |
| | Charge Transport Layer | | | | | | | | | | High | | High |
| | Charge- | Poly- | Polyester Resin | | | | | | Poten- | | Temper- | | Temper- |
| | Trans- | carbon- | | | | | | (Mmax − | tial | Normal | ature | Normal | ature |
| | porting | ate | Unit | Unit | Mw | Mmax | Mmin | Mmin)/ | Distri- | Environ- | and High | Environ- | and High |
| | Material | Resin | (A) | (B) | (×10⁴) | (×10⁴) | (×10⁴) | Mw | bution | ment | Humidity | ment | Humidity |
| Example S1 | CTM-1 | — | A2-3 | B1-4 | 7.0 | 7.0 | 4.0 | 0.43 | A | A | A | A | A |
| Comparative | CTM-1 | — | A2-3 | B1-4 | 7.0 | — | — | — | B | B | C | B | C |
| Example S1 | | | | | | | | | | | | | |
| Comparative | CTM-1 | — | A2-3 | B1-4 | 7.0 | 7.0 | 4.5 | 0.36 | B | B | C | B | C |
| Example S2 | | | | | | | | | | | | | |
| Comparative | CTM-1 | — | A2-3 | B1-4 | 7.0 | 38.0 | 2.5 | 5.07 | B | B | C | B | C |
| Example S3 | | | | | | | | | | | | | |
| Comparative | CTM-1 | — | A2-3 | B1-4 | 4.5 | 6.5 | 4.5 | 0.44 | A | B | C | C | C |
| Example S4 | | | | | | | | | | | | | |
| Comparative | CTM-1 | — | A2-3 | B1-4 | 21.0 | 21.0 | 11.0 | 0.48 | C | B | B | B | C |
| Example S5 | | | | | | | | | | | | | |
| Example S2 | CTM-1 | — | A2-3 | B1-4 | 7.0 | 7.5 | 3.5 | 0.57 | A+ | A+ | A | A | A |
| Example S3 | CTM-1 | — | A2-3 | B1-4 | 7.0 | 11.0 | 6.0 | 0.71 | A+ | A+ | A | A+ | A |
| Example S4 | CTM-1 | — | A2-3 | B1-4 | 7.0 | 30.0 | 3.0 | 3.86 | A+ | A+ | A | A+ | A |
| Example S5 | CTM-1 | — | A2-3 | B1-4 | 7.0 | 33.0 | 4.0 | 4.14 | A+ | A | A | A+ | A |
| Example S6 | CTM-1 | — | A2-3 | B1-4 | 7.0 | 35.0 | 3.0 | 4.57 | A | A | A | A | A |
| Example S7 | CTM-1 | — | A2-3 | B1-4 | 8.5 | 13.0 | 5.0 | 0.94 | A+ | A+ | A | A+ | A+ |
| Example S8 | CTM-1 | — | A2-3 | B1-4 | 10.0 | 12.0 | 4.0 | 0.80 | A+ | A+ | A+ | A+ | A+ |
| Example S9 | CTM-1 | — | A2-3 | B1-4 | 12.0 | 15.0 | 5.0 | 0.83 | A+ | A+ | A+ | A+ | A+ |
| Example S10 | CTM-1 | — | A2-3 | B1-4 | 14.0 | 14.0 | 4.0 | 0.71 | A | A+ | A+ | A+ | A+ |
| Example S11 | CTM-1 | — | A2-3 | B1-4 | 15.5 | 15.5 | 5.0 | 0.68 | A | A+ | A+ | A+ | A |
| Example S12 | CTM-1 | — | A2-3 | B1-2 | 11.0 | 12.0 | 4.0 | 0.73 | A+ | A+ | A+ | A+ | A+ |
| Example S13 | CTM-1 | — | A1-1 | B1-4 | 11.0 | 20.0 | 4.5 | 1.41 | A+ | A+ | A | A+ | A |
| | | | A1-7 | | | | | | | | | | |
| Example S14 | CTM-1 | — | A3-2 | B1-4 | 10.0 | 16.5 | 6.0 | 1.05 | A+ | A+ | A | A+ | A+ |
| Example S15 | CTM-1 | — | A4-3 | B1-4 | 9.0 | 15.0 | 4.0 | 1.22 | A | A+ | A+ | A+ | A+ |
| Example S16 | CTM-1 | — | A2-3 | B2-6 | 11.0 | 11.0 | 3.0 | 0.73 | A+ | A+ | A+ | A+ | A+ |
| Example S17 | CTM-1 | — | A2-3 | B3-3 | 9.5 | 16.0 | 7.0 | 0.95 | A | A+ | A | A | A |
| Example S18 | CTM-1 | — | A2-3 | B4-3 | 11.0 | 14.0 | 5.0 | 0.82 | A+ | A+ | A | A | A |
| Example S19 | CTM-1 | — | A2-3 | B5-1 | 10.0 | 10.0 | 3.5 | 0.65 | A+ | A+ | A | A+ | A |
| Example S20 | CTM-1 | — | A2-3 | B6-4 | 12.0 | 14.5 | 6.0 | 0.71 | A+ | A+ | A | A+ | A+ |
| Example S21 | CTM-1 | — | A3-2 | B1-2 | 10.5 | 20.0 | 10.5 | 0.90 | A+ | A+ | A+ | A+ | A |
| Example S22 | CTM-1 | — | A3-2 | B1-2 | 9.5 | 9.5 | 3.0 | 0.68 | A | A+ | A+ | A+ | A+ |
| | | | | B7-2 | | | | | | | | | |
| Example S23 | CTM-1 | — | A3-2 | B6-4 | 10.0 | 11.0 | 4.0 | 0.70 | A+ | A+ | A | A+ | A |
| | | | A4-3 | | | | | | | | | | |
| Example S24 | CTM-1 | — | A3-2 | B4-4 | 9.0 | 9.0 | 3.0 | 0.67 | A+ | A | A | A | A |
| Example S25 | CTM-1 | PC-1 | A2-3 | B1-4 | 9.5 | 12.0 | 5.0 | 0.74 | A+ | A+ | A+ | A+ | A+ |
| Example S26 | CTM-2 | — | A2-3 | B1-4 | 10.0 | 12.0 | 4.0 | 0.80 | A+ | A+ | A+ | A+ | A+ |
| Example S27 | CTM-3 | — | A2-3 | B1-4 | 10.0 | 12.0 | 4.0 | 0.80 | A+ | A+ | A+ | A+ | A+ |
| Example S28 | CTM-1 | — | A2-3 | B1-4 | 10.0 | 12.0 | 4.0 | 0.80 | A+ | A+ | A+ | A+ | A+ |
| | CTM-3 | | | | | | | | | | | | |
| Example S29 | CTM-4 | — | A2-3 | B1-4 | 10.0 | 12.0 | 4.0 | 0.80 | A+ | A+ | A+ | A+ | A+ |

TABLE 2

| | | | | | | | | Performance of Photoreceptor | | | | |
|---|---|---|---|---|---|---|---|---|---|---|---|---|
| | | | | | | | | | Image After Fall | | Storage Stability | |
| | Single layer type Photosensitive Layer | | | | | | | | | High | | High |
| | Poly- | Polyester Resin | | | | | | Poten- | | Temper- | | Temper- |
| | carbon- | | | | | | (Mmax − | tial | Normal | ature | Normal | ature |
| | ate | Unit | Unit | Mw | Mmax | Mmin | Mmin)/ | Distri- | Environ- | and High | Environ- | and High |
| | Resin | (A) | (B) | (×10⁴) | (×10⁴) | (×10⁴) | Mw | bution | ment | Humidity | ment | Humidity |
| Example T1 | — | A2-3 | B1-4 | 7.0 | 7.0 | 4.0 | 0.43 | B | B | A | A | A |
| Comparative | — | A2-3 | B1-4 | 7.0 | — | — | — | C | C | C | B | C |
| Example T1 | | | | | | | | | | | | |
| Comparative | — | A2-3 | B1-4 | 7.0 | 7.0 | 4.5 | 0.36 | C | C | C | B | C |
| Example T2 | | | | | | | | | | | | |
| Comparative | — | A2-3 | B1-4 | 7.0 | 38.0 | 2.5 | 5.07 | C | C | C | B | C |
| Example T3 | | | | | | | | | | | | |
| Comparative | — | A2-3 | B1-4 | 4.5 | 6.5 | 4.5 | 0.44 | B | C | C | C | C |
| Example T4 | | | | | | | | | | | | |
| Comparative | — | A2-3 | B1-4 | 21.0 | 21.0 | 11.0 | 0.48 | C | C | B | B | C |
| Example T5 | | | | | | | | | | | | |
| Example T2 | — | A2-3 | B1-4 | 7.0 | 7.5 | 3.5 | 0.57 | A | A | A | A | A |
| Example T3 | — | A2-3 | B1-4 | 7.0 | 11.0 | 6.0 | 0.71 | A | A | A | A+ | A |
| Example T4 | — | A2-3 | B1-4 | 7.0 | 30.0 | 3.0 | 3.86 | A | A | A | A+ | A |
| Example T5 | — | A2-3 | B1-4 | 7.0 | 33.0 | 4.0 | 4.14 | A | B | A | A+ | A |
| Example T6 | — | A2-3 | B1-4 | 7.0 | 35.0 | 3.0 | 4.57 | B | B | A | A | A |
| Example T7 | — | A2-3 | B1-4 | 8.5 | 13.0 | 5.0 | 0.94 | A | A | A | A+ | A+ |
| Example T8 | — | A2-3 | B1-4 | 10.0 | 12.0 | 4.0 | 0.80 | A | A | A+ | A+ | A+ |
| Example T9 | — | A2-3 | B1-4 | 12.0 | 15.0 | 5.0 | 0.83 | A | A | A+ | A+ | A+ |
| Example T10 | — | A2-3 | B1-4 | 14.0 | 14.0 | 4.0 | 0.71 | B | A | A+ | A+ | A+ |
| Example T11 | — | A2-3 | B1-4 | 15.5 | 15.5 | 5.0 | 0.68 | B | A | A+ | A+ | A |
| Example T12 | PC-1 | A2-3 | B1-4 | 9.5 | 12.0 | 5.0 | 0.74 | A | A | A+ | A+ | A+ |
| Example T13 | — | A3-2 | B1-2 | 10.5 | 20.0 | 10.5 | 0.90 | A | A | A+ | A+ | A |
| Example T14 | — | A3-2 | B4-4 | 9.0 | 9.0 | 3.0 | 0.67 | A | B | A | A | A |

The electrophotographic photoreceptor, the process cartridge, and the image forming apparatus according to the present disclosure include the following aspects. The formulas are the same as the formulas with the same corresponding numbers described above.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An electrophotographic photoreceptor including:
   a conductive substrate; and
   a multilayer-type photosensitive layer that is disposed on the conductive substrate and has a charge generation layer and a charge transport layer,
   wherein the charge transport layer contains a charge-transporting material and a polyester resin (1) having a dicarboxylic acid unit (A) represented by formula (A) and a diol unit (B) represented by formula (B), and
   the polyester resin (1) contained in the charge transport layer has a molecular weight distribution curve with at least two peaks and satisfies 50,000≤Mw≤200,000, and 0.4≤(Mmax−Mmin)/Mw≤5.0, wherein Mmin is a molecular weight at a top of a peak corresponding to a lowest molecular weight, Mmax is a molecular weight at a top of a peak corresponding to a highest molecular weight, and Mw is a weight average molecular weight of the polyester resin (1) contained in the charge transport layer:

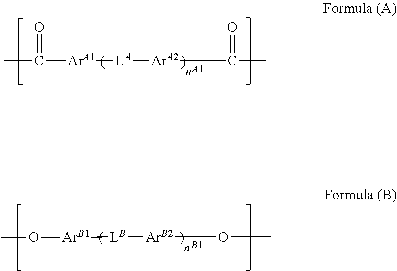

in formula (A), Ar^{A1} and Ar^{A2} are each independently an optionally substituted aromatic ring, L^{A} is a single bond or a divalent linking group, and n^{A1} is 0, 1, or 2; and
in formula (B), Ar^{B1} and Ar^{B2} are each independently an optionally substituted aromatic ring, LB is a single bond, an oxygen atom, a sulfur atom, or —C(Rb¹)(Rb²)—, and n^{B1} is 0, 1, or 2; and Rb¹ and Rb² are each independently a hydrogen atom, a C1-C20 alkyl group, a C6-C12 aryl group, or a C7-C20 aralkyl group, and Rb¹ and Rb² taken together may form a cyclic alkyl group.
(((2))) The electrophotographic photoreceptor according to (((1))), wherein the polyester resin (1) satisfies 0.5≤(Mmax−Mmin)/Mw≤4.5.
(((3))) The electrophotographic photoreceptor according to (((1))) or (((2))), wherein the polyester resin (1) satisfies 80,000≤Mw≤150,000.
(((4))) The electrophotographic photoreceptor according to any one of (((1))) to (((3))), wherein the dicarboxylic acid unit (A) includes at least one selected from the group consisting of a dicarboxylic acid unit (A1) represented by formula (A1), a dicarboxylic acid unit (A2) represented by formula (A2), a dicarboxylic acid unit (A3) represented by formula (A3), and a dicarboxylic acid unit (A4) represented by formula (A4):

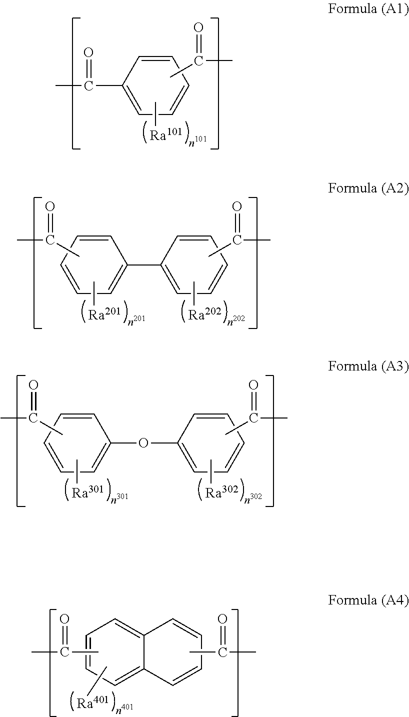

in formula (A1), n¹⁰¹ is an integer of 0 or more and 4 or less, n¹⁰¹ Ra¹⁰¹'s are each independently a C1-C10 alkyl group, a C6-C12 aryl group, or a C1-C6 alkoxy group;
in formula (A2), n²⁰¹ and n²⁰² are each independently an integer of 0 or more and 4 or less, n²⁰¹ Ra²⁰¹'s and n²⁰² Ra²⁰²'s are each independently a C1-C10 alkyl group, a C6-C12 aryl group, or a C1-C6 alkoxy group;
in formula (A3), n³⁰¹ and n³⁰² are each independently an integer of 0 or more and 4 or less, n³⁰¹ Ra³⁰¹'s and n³⁰² Ra³⁰²'s are each independently a C1-C10 alkyl group, a C6-C12 aryl group, or a C1-C6 alkoxy group; and
in formula (A4), n⁴⁰¹ is an integer of 0 or more and 6 or less, n⁴⁰¹ Ra⁴⁰¹'s are each independently a C1-C10 alkyl group, a C6-C12 aryl group, or a C1-C6 alkoxy group.
(((5))) The electrophotographic photoreceptor according to (((4))), wherein the dicarboxylic acid unit (A) includes at least one selected from the group consisting of the dicarboxylic acid unit (A2), the dicarboxylic acid unit (A3), and the dicarboxylic acid unit (A4).
(((6))) The electrophotographic photoreceptor according to any one of (((1))) to (((5))), wherein the diol unit (B) includes at least one selected from the group consisting of a diol unit (B1) represented by formula (B1), a diol unit (B2) represented by formula (B2), a diol unit (B3) represented by formula (B3), a diol unit (B4) represented by formula (B4), a diol unit (B5) represented by formula (B5), a diol unit (B6) represented by formula (B6), a diol unit (B7) represented by formula (B7), and a diol unit (B8) represented by formula (B8):

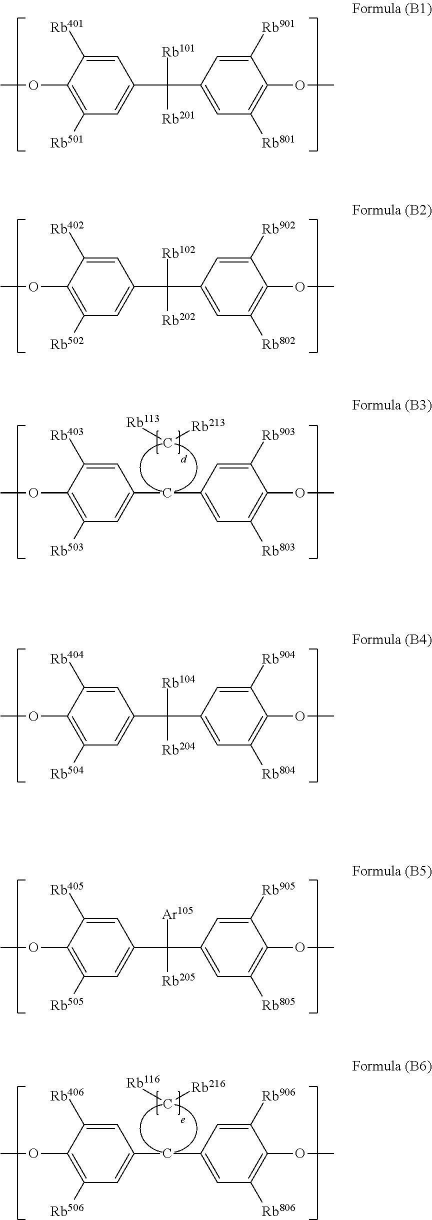

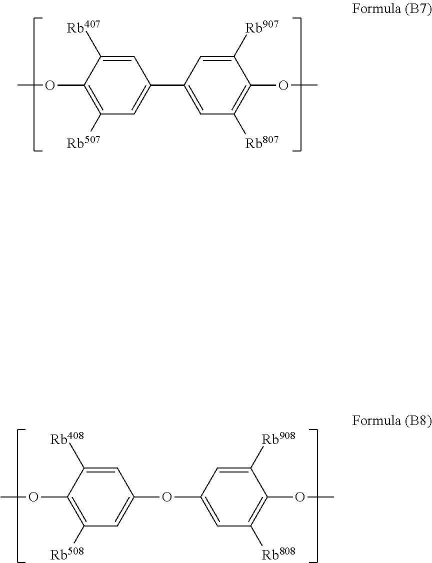

in formula (B1), Rb¹⁰¹ is a C4-C20 branched alkyl group, Rb²⁰¹ is a hydrogen atom or a C1-C3 alkyl group, and Rb⁴⁰¹, Rb⁵⁰¹, Rb⁸⁰¹, and Rb⁹⁰¹ are each independently a hydrogen atom, a C1-C4 alkyl group, a C1-C6 alkoxy group, or a halogen atom;
in formula (B2), Rb¹⁰² is a C4-C20 linear alkyl group, Rb²⁰² is a hydrogen atom or a C1-C3 alkyl group, and Rb⁴⁰², Rb⁵⁰², Rb⁸⁰², and Rb⁹⁰² are each independently a hydrogen atom, a C1-C4 alkyl group, a C1-C6 alkoxy group, or a halogen atom;
in formula (B3), Rb¹¹³ and Rb²¹³ are each independently a hydrogen atom, a C1-C3 linear alkyl group, a C1-C4 alkoxy group, or a halogen atom, d is an integer of 7 or more and 15 or less, and Rb⁴⁰³, Rb⁵⁰³, Rb⁸⁰³, and Rb⁹⁰³ are each independently a hydrogen atom, a C1-C4 alkyl group, a C1-C6 alkoxy group, or a halogen atom;
in formula (B4), Rb¹⁰⁴ and Rb²⁰⁴ are each independently a hydrogen atom or a C1-C3 alkyl group, and Rb⁴⁰⁴, Rb⁵⁰⁴, Rb⁸⁰⁴, and Rb⁹⁰⁴ are each independently a hydrogen atom, a C1-C4 alkyl group, a C1-C6 alkoxy group, or a halogen atom;
in formula (B5), Ar¹⁰⁵ is a C6-C12 aryl group or a C7-C20 aralkyl group, Rb²⁰⁵ is a hydrogen atom or a C1-C3 alkyl group, and Rb⁴⁰⁵, Rb⁵⁰⁵, Rb⁸⁰⁵, and Rb⁹⁰⁵ are each independently a hydrogen atom, a C1-C4 alkyl group, a C1-C6 alkoxy group, or a halogen atom;
in formula (B6), Rb¹¹⁶ and Rb²¹⁶ are each independently a hydrogen atom, a C1-C3 linear alkyl group, a C1-C4 alkoxy group, or a halogen atom, e is an integer of 4 or more and 6 or less, and Rb⁴⁰⁶, Rb⁵⁰⁶, Rb⁸⁰⁶, and Rb⁹⁰⁶ are each independently a hydrogen atom, a C1-C4 alkyl group, a C1-C6 alkoxy group, or a halogen atom;
in formula (B7), Rb⁴⁰⁷, Rb⁵⁰⁷, Rb⁸⁰⁷, and Rb⁹⁰⁷ are each independently a hydrogen atom, a C1-C4 alkyl group, a C1-C6 alkoxy group, or a halogen atom; and
in formula (B8), Rb⁴⁰⁸, Rb⁵⁰⁸, Rb⁸⁰⁸, and Rb⁹⁰⁸ are each independently a hydrogen atom, a C1-C4 alkyl group, a C1-C6 alkoxy group, or a halogen atom.
(((7))) The electrophotographic photoreceptor according to (((6))), wherein the diol unit (B) includes at least one selected from the group consisting of the diol unit (B1), the diol unit (B2), the diol unit (B5), and the diol unit (B6).
(((8))) An electrophotographic photoreceptor including:
   a conductive substrate; and
   a single layer type photosensitive layer that is disposed on the conductive substrate,
   wherein the single layer type photosensitive layer contains a charge-transporting material and a polyester resin (1) having a dicarboxylic acid unit (A) represented by formula (A) and a diol unit (B) represented by formula (B), and
   the polyester resin (1) contained in the single layer type photosensitive layer has a molecular weight distribution curve with at least two peaks and satisfies 50,000≤Mw≤200,000, and 0.4≤(Mmax−Mmin)/Mw≤5.0, wherein Mmin is a molecular weight at a top of a peak corresponding to a lowest molecular weight, Mmax is a molecular weight at a top of a peak corresponding to a highest molecular weight, and Mw is a weight average molecular weight of the polyester resin (1) contained in the single layer type photosensitive layer:

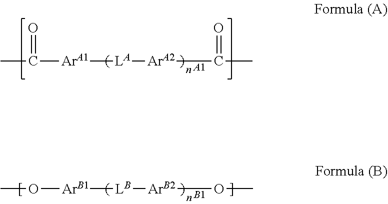

in formula (A), Ar^{A1} and Ar^{A2} are each independently an optionally substituted aromatic ring, L^{A} is a single bond or a divalent linking group, and n^{A1} is 0, 1, or 2; and
in formula (B), Ar^{B1} and Ar^{B2} are each independently an optionally substituted aromatic ring, LB is a single bond, an oxygen atom, a sulfur atom, or —C(Rb¹)(Rb²)—, and n^{B1} is 0, 1, or 2; and Rb¹ and Rb² are each independently a hydrogen atom, a C1-C20 alkyl group, a C6-C12 aryl group, or a C7-C20 aralkyl group, and Rb′ and Rb² taken together may form a cyclic alkyl group.
(((9))) The electrophotographic photoreceptor according to (((8))), wherein the polyester resin (1) satisfies 0.5≤(Mmax−Mmin)/Mw≤4.5.
(((10))) The electrophotographic photoreceptor according to (((8))) or (((9))), wherein the polyester resin (1) satisfies 80,000≤Mw≤150,000.
(((11))) The electrophotographic photoreceptor according to any one of (((8))) to (((10))), wherein the dicarboxylic acid unit (A) includes at least one selected from the group consisting of a dicarboxylic acid unit (A1) represented by formula (A1), a dicarboxylic acid unit (A2) represented by formula (A2), a dicarboxylic acid unit (A3) represented by formula (A3), and a dicarboxylic acid unit (A4) represented by formula (A4):

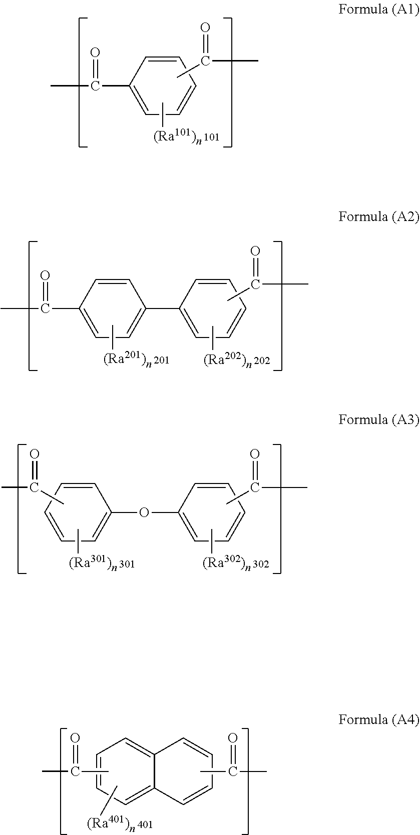

in formula (A1), n¹⁰¹ is an integer of 0 or more and 4 or less, n¹⁰¹ Ra¹⁰¹'s are each independently a C1-C10 alkyl group, a C6-C12 aryl group, or a C1-C6 alkoxy group;
in formula (A2), n²⁰¹ and n²⁰² are each independently an integer of 0 or more and 4 or less, n²⁰¹ Ra²⁰¹'s and n²⁰² Ra²⁰²'s are each independently a C1-C10 alkyl group, a C6-C12 aryl group, or a C1-C6 alkoxy group;
in formula (A3), n³⁰¹ and n³⁰² are each independently an integer of 0 or more and 4 or less, n³⁰¹ Ra³⁰¹'s and n³⁰² Ra³⁰²'s are each independently a C1-C10 alkyl group, a C6-C12 aryl group, or a C1-C6 alkoxy group; and
in formula (A4), n⁴⁰¹ is an integer of 0 or more and 6 or less, n⁴⁰¹ Ra⁴⁰¹'s are each independently a C1-C10 alkyl group, a C6-C12 aryl group, or a C1-C6 alkoxy group.
(((12))) The electrophotographic photoreceptor according to (((11))), wherein the dicarboxylic acid unit (A) includes at least one selected from the group consisting of the dicarboxylic acid unit (A2), the dicarboxylic acid unit (A3), and the dicarboxylic acid unit (A4).
(((13))) The electrophotographic photoreceptor according to any one of (((8))) to (((12))), wherein the diol unit (B) includes at least one selected from the group consisting of a diol unit (B1) represented by formula (B1), a diol unit (B2) represented by formula (B2), a diol unit (B3) represented by formula (B3), a diol unit (B4) represented by formula (B4), a diol unit (B5) represented by formula (B5), a diol unit (B6) represented by formula (B6), a diol unit (B7) represented by formula (B7), and a diol unit (B8) represented by formula (B8):

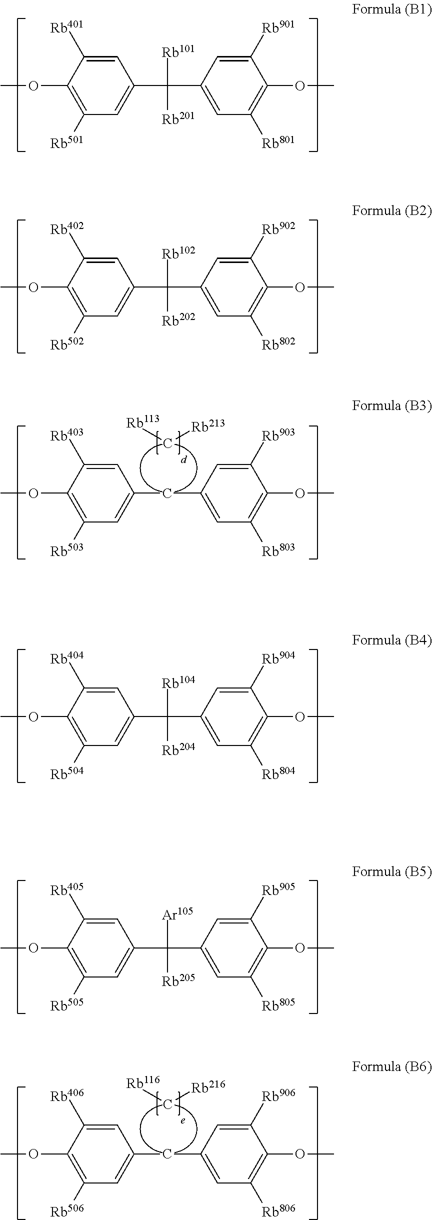

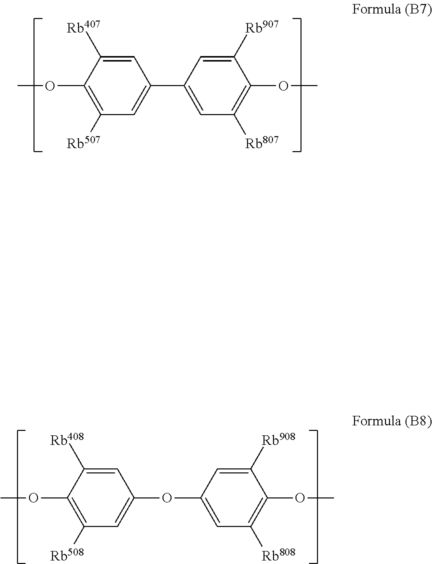

in formula (B1), Rb¹⁰¹ is a C4-C20 branched alkyl group, Rb²⁰¹ is a hydrogen atom or a C1-C3 alkyl group, and Rb⁴⁰¹, Rb⁵⁰¹, Rb⁸⁰¹, and Rb⁹⁰¹ are each independently a hydrogen atom, a C1-C4 alkyl group, a C1-C6 alkoxy group, or a halogen atom;
in formula (B2), Rb¹⁰² is a C4-C20 linear alkyl group, Rb²⁰² is a hydrogen atom or a C1-C3 alkyl group, and Rb⁴⁰², Rb⁵⁰², Rb⁸⁰², and Rb⁹⁰² are each independently a hydrogen atom, a C1-C4 alkyl group, a C1-C6 alkoxy group, or a halogen atom;
in formula (B3), Rb¹¹³ and Rb²¹³ are each independently a hydrogen atom, a C1-C3 linear alkyl group, a C1-C4 alkoxy group, or a halogen atom, d is an integer of 7 or more and 15 or less, and Rb⁴⁰³, Rb⁵⁰³, Rb⁸⁰³, and Rb⁹⁰³ are each independently a hydrogen atom, a C1-C4 alkyl group, a C1-C6 alkoxy group, or a halogen atom;
in formula (B4), Rb¹⁰⁴ and Rb²⁰⁴ are each independently a hydrogen atom or a C1-C3 alkyl group, and Rb⁴⁰⁴, Rb⁵⁰⁴, Rb⁸⁰⁴, and Rb⁹⁰⁴ are each independently a hydrogen atom, a C1-C4 alkyl group, a C1-C6 alkoxy group, or a halogen atom;
in formula (B5), Ar¹⁰⁵ is a C6-C12 aryl group or a C7-C20 aralkyl group, Rb²⁰⁵ is a hydrogen atom or a C1-C3 alkyl group, and Rb⁴⁰⁵, Rb⁵⁰⁵, Rb⁸⁰⁵, and Rb⁹⁰⁵ are each independently a hydrogen atom, a C1-C4 alkyl group, a C1-C6 alkoxy group, or a halogen atom;
in formula (B6), Rb¹¹⁶ and Rb²¹⁶ are each independently a hydrogen atom, a C1-C3 linear alkyl group, a C1-C4 alkoxy group, or a halogen atom, e is an integer of 4 or more and 6 or less, and Rb⁴⁰⁶, Rb⁵⁰⁶, Rb⁸⁰⁶, and Rb⁹⁰⁶ are each independently a hydrogen atom, a C1-C4 alkyl group, a C1-C6 alkoxy group, or a halogen atom;
in formula (B7), Rb⁴⁰⁷, Rb⁵⁰⁷, Rb⁸⁰⁷, and Rb⁹⁰⁷ are each independently a hydrogen atom, a C1-C4 alkyl group, a C1-C6 alkoxy group, or a halogen atom; and
in formula (B8), Rb⁴⁰⁸, Rb⁵⁰⁸, Rb⁸⁰⁸, and Rb⁹⁰⁸ are each independently a hydrogen atom, a C1-C4 alkyl group, a C1-C6 alkoxy group, or a halogen atom.
(((14))) The electrophotographic photoreceptor according to (((13))), wherein the diol unit (B) includes at least one selected from the group consisting of the diol unit (B1), the diol unit (B2), the diol unit (B5), and the diol unit (B6).
(((15))) A process cartridge including the electrophotographic photoreceptor according to any one of (((1))) to (((14))),
   wherein the process cartridge is attachable to and detachable from an image forming apparatus.
(((16))) An image forming apparatus including:
   the electrophotographic photoreceptor according to any one of (((1))) to (((14))
   a charging device that charges a surface of the electrophotographic photoreceptor;
   an electrostatic latent image-forming device that forms an electrostatic latent image on the charged surface of the electrophotographic photoreceptor;
   a developing device that develops the electrostatic latent image on the surface of the electrophotographic photoreceptor by using a developer containing a toner to form a toner image; and
   a transfer device that transfers the toner image to a surface of a recording medium.

What is claimed is:

1. An electrophotographic photoreceptor comprising:
a conductive substrate; and
a multilayer-type photosensitive layer that is disposed on the conductive substrate and has a charge generation layer and a charge transport layer,
wherein the charge transport layer contains a charge-transporting material and a polyester resin (1) having a dicarboxylic acid unit (A) represented by formula (A) and a diol unit (B) represented by formula (B), and
the polyester resin (1) contained in the charge transport layer has a molecular weight distribution curve with at least two peaks and satisfies 50,000≤Mw≤200,000, and 0.4≤(Mmax−Mmin)/Mw≤5.0, wherein Mmin is a molecular weight at a top of a peak corresponding to a lowest molecular weight, Mmax is a molecular weight at a top of a peak corresponding to a highest molecular weight, and Mw is a weight average molecular weight of the polyester resin (1) contained in the charge transport layer: 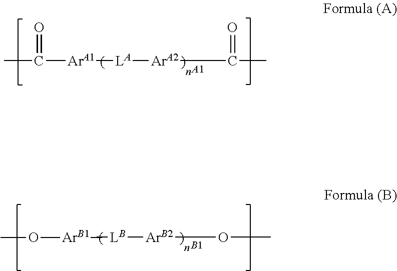
in formula (A), Ar^{A1} and Ar^{A2} are each independently an optionally substituted aromatic ring, L^{A} is a single bond or a divalent linking group, and n^{A1} is 0, 1, or 2; and
in formula (B), Ar^{B1} and Ar^{B2} are each independently an optionally substituted aromatic ring, LB is a single bond, an oxygen atom, a sulfur atom, or —C(Rb¹) (Rb³)—, n^{B1} is 0, 1, or 2; Rb¹ and Rb² are each independently a hydrogen atom, a C1-C20 alkyl group, a C6-C12 aryl group, or a C7-C20 aralkyl group, and Rb¹ and Rb² taken together may form a cyclic alkyl group.

2. The electrophotographic photoreceptor according to claim 1, wherein the polyester resin (1) satisfies 0.5≤(Mmax−Mmin)/Mw≤4.5.

3. The electrophotographic photoreceptor according to claim 1, wherein the polyester resin (1) satisfies 80,000≤Mw≤150,000.

4. The electrophotographic photoreceptor according to claim 1, wherein the dicarboxylic acid unit (A) includes at least one selected from the group consisting of a dicarboxylic acid unit (A1) represented by formula (A1), a dicarboxylic acid unit (A2) represented by formula (A2), a dicarboxylic acid unit (A3) represented by formula (A3), and a dicarboxylic acid unit (A4) represented by formula (A4): 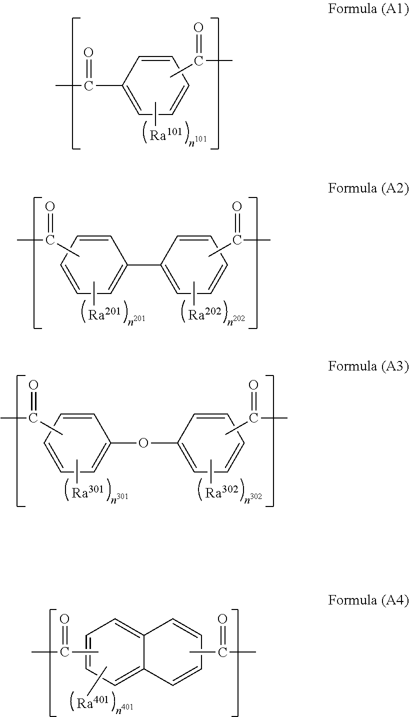
in formula (A1), n¹⁰¹ is an integer of 0 or more and 4 or less, n¹⁰¹ Ra¹⁰¹'s are each independently a C1-C10 alkyl group, a C6-C12 aryl group, or a C1-C6 alkoxy group;
in formula (A2), n²⁰¹ and n²⁰² are each independently an integer of 0 or more and 4 or less, n²⁰¹ Ra²⁰¹'s and n²⁰² Ra²⁰²'s are each independently a C1-C10 alkyl group, a C6-C12 aryl group, or a C1-C6 alkoxy group;
in formula (A3), n³⁰¹ and n³⁰² are each independently an integer of 0 or more and 4 or less, n³⁰¹ Ra³⁰¹'s and n³⁰² Ra³⁰²'s are each independently a C1-C10 alkyl group, a C6-C12 aryl group, or a C1-C6 alkoxy group; and
in formula (A4), n⁴⁰¹ is an integer of 0 or more and 6 or less, n⁴⁰¹ Ra⁴⁰¹'s are each independently a C1-C10 alkyl group, a C6-C12 aryl group, or a C1-C6 alkoxy group.

5. The electrophotographic photoreceptor according to claim 4, wherein the dicarboxylic acid unit (A) includes at least one selected from the group consisting of the dicarboxylic acid unit (A2), the dicarboxylic acid unit (A3), and the dicarboxylic acid unit (A4).

6. The electrophotographic photoreceptor according to claim 1, wherein the diol unit (B) includes at least one selected from the group consisting of a diol unit (B1) represented by formula (B1), a diol unit (B2) represented by formula (B2), a diol unit (B3) represented by formula (B3), a diol unit (B4) represented by formula (B4), a diol unit (B5) represented by formula (B5), a diol unit (B6) represented by formula (B6), a diol unit (B7) represented by formula (B7), and a diol unit (B8) represented by formula (B8): 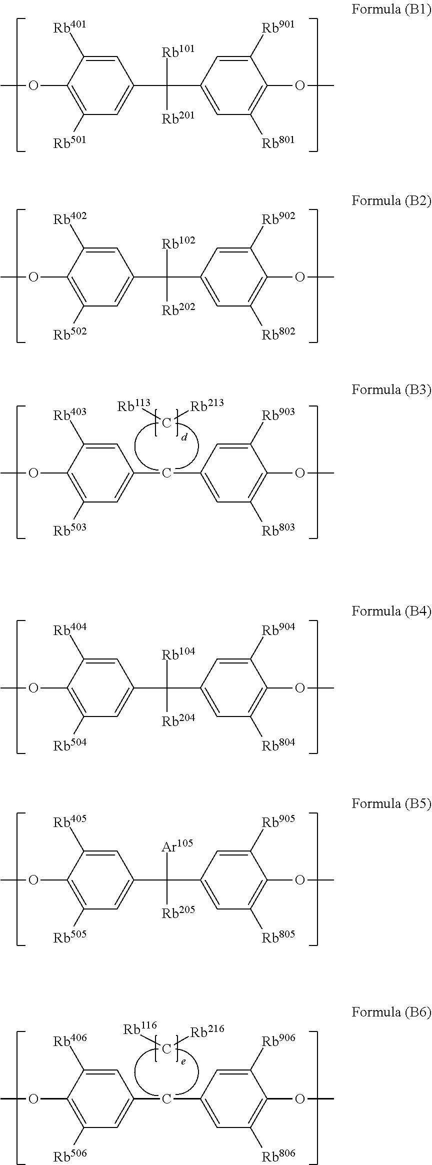 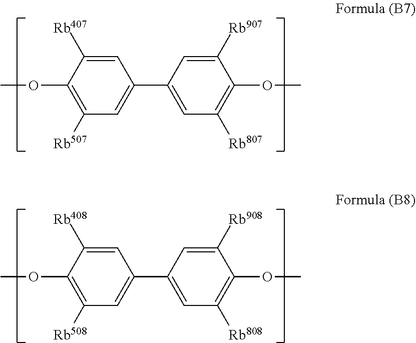
in formula (B1), Rb¹⁰¹ is a C4-C20 branched alkyl group, Rb²⁰¹ is a hydrogen atom or a C1-C3 alkyl group, and Rb⁴⁰¹, Rb⁵⁰¹, Rb⁸⁰¹, and Rb⁹⁰¹ are each independently a hydrogen atom, a C1-C4 alkyl group, a C1-C6 alkoxy group, or a halogen atom;
in formula (B2), Rb¹⁰² is a C4-C20 linear alkyl group, Rb²⁰² is a hydrogen atom or a C1-C3 alkyl group, and Rb⁴⁰², Rb⁵⁰², Rb⁸⁰², and Rb⁹⁰² are each independently a hydrogen atom, a C1-C4 alkyl group, a C1-C6 alkoxy group, or a halogen atom;
in formula (B3), Rb¹¹³ and Rb²¹³ are each independently a hydrogen atom, a C1-C3 linear alkyl group, a C1-C4 alkoxy group, or a halogen atom, d is an integer of 7 or more and 15 or less, and Rb⁴⁰³, Rb⁵⁰³, Rb⁸⁰³, and Rb⁹⁰³ are each independently a hydrogen atom, a C1-C4 alkyl group, a C1-C6 alkoxy group, or a halogen atom;
in formula (B4), Rb¹⁰⁴ and Rb²⁰⁴ are each independently a hydrogen atom or a C1-C3 alkyl group, and Rb⁴⁰⁴, Rb⁵⁰⁴, Rb⁸⁰⁴, and Rb⁹⁰⁴ are each independently a hydrogen atom, a C1-C4 alkyl group, a C1-C6 alkoxy group, or a halogen atom;
in formula (B5), Ar¹⁰⁵ is a C6-C12 aryl group or a C7-C20 aralkyl group, Rb²⁰⁵ is a hydrogen atom or a C1-C3 alkyl group, and Rb⁴⁰⁵, Rb⁵⁰⁵, Rb⁸⁰⁵, and Rb⁹⁰⁵ are each independently a hydrogen atom, a C1-C4 alkyl group, a C1-C6 alkoxy group, or a halogen atom;
in formula (B6), Rb¹¹⁶ and Rb²¹⁶ are each independently a hydrogen atom, a C1-C3 linear alkyl group, a C1-C4 alkoxy group, or a halogen atom, e is an integer of 4 or more and 6 or less, and Rb⁴⁰⁶, Rb⁵⁰⁶, Rb⁸⁰⁶, and Rb⁹⁰⁶ are each independently a hydrogen atom, a C1-C4 alkyl group, a C1-C6 alkoxy group, or a halogen atom;
in formula (B7), Rb⁴⁰⁷, Rb⁵⁰⁷, Rb⁸⁰⁷, and Rb⁹⁰⁷ are each independently a hydrogen atom, a C1-C4 alkyl group, a C1-C6 alkoxy group, or a halogen atom; and
in formula (B8), Rb⁴⁰⁸, Rb⁵⁰⁸, Rb⁸⁰⁸, and Rb⁹⁰⁸ are each independently a hydrogen atom, a C1-C4 alkyl group, a C1-C6 alkoxy group, or a halogen atom.

7. The electrophotographic photoreceptor according to claim 6, wherein the diol unit (B) includes at least one selected from the group consisting of the diol unit (B1), the diol unit (B2), the diol unit (B5), and the diol unit (B6).

8. An electrophotographic photoreceptor comprising:
a conductive substrate; and
a single layer type photosensitive layer that is disposed on the conductive substrate,
wherein the single layer type photosensitive layer contains a charge-transporting material and a polyester resin (1) having a dicarboxylic acid unit (A) represented by formula (A) and a diol unit (B) represented by formula (B), and
the polyester resin (1) contained in the single layer type photosensitive layer has a molecular weight distribution curve with at least two peaks and satisfies 50,000≤Mw≤200,000, and 0.4≤(Mmax−Mmin)/Mw≤5.0, wherein Mmin is a molecular weight at a top of a peak corresponding to a lowest molecular weight, Mmax is a molecular weight at a top of a peak corresponding to a highest molecular weight, and Mw is a weight average molecular weight of the polyester resin (1) contained in the single layer type photosensitive layer: 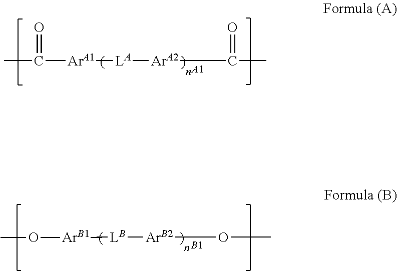
in formula (A), Ar^{A1} and Ar^{A2} are each independently an optionally substituted aromatic ring, L^{A} is a single bond or a divalent linking group, and n^{A1} is 0, 1, or 2; and
in formula (B), Ar^{B1} and Ar^{B2} are each independently an optionally substituted aromatic ring, LB is a single bond, an oxygen atom, a sulfur atom, or —C(Rb¹)(Rb²)—, and n^{B1} is 0, 1, or 2; and Rb¹ and Rb² are each independently a hydrogen atom, a C1-C20 alkyl group, a C6-C12 aryl group, or a C7-C20 aralkyl group, and Rb¹ and Rb² taken together may form a cyclic alkyl group.

9. The electrophotographic photoreceptor according to claim 8, wherein the polyester resin (1) satisfies 0.5≤(Mmax−Mmin)/Mw≤4.5.

10. The electrophotographic photoreceptor according to claim 8, wherein the polyester resin (1) satisfies 80,000≤Mw≤150,000.

11. The electrophotographic photoreceptor according to claim 8, wherein the dicarboxylic acid unit (A) includes at least one selected from the group consisting of a dicarboxylic acid unit (A1) represented by formula (A1), a dicarboxylic acid unit (A2) represented by formula (A2), a dicarboxylic acid unit (A3) represented by formula (A3), and a dicarboxylic acid unit (A4) represented by formula (A4): 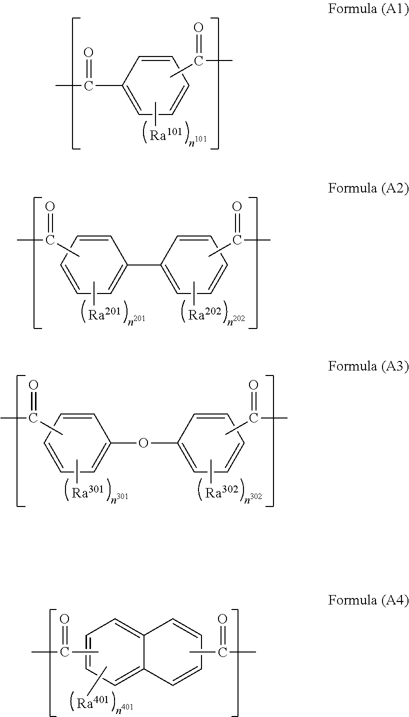
in formula (A1), n¹⁰¹ is an integer of 0 or more and 4 or less, n¹⁰¹ Ra¹⁰¹'s are each independently a C1-C10 alkyl group, a C6-C12 aryl group, or a C1-C6 alkoxy group;
in formula (A2), n²⁰¹ and n²⁰² are each independently an integer of 0 or more and 4 or less, n²⁰¹ Ra²⁰¹'s and n²⁰² Ra²⁰²'s are each independently a C1-C10 alkyl group, a C6-C12 aryl group, or a C1-C6 alkoxy group;
in formula (A3), n³⁰¹ and n³⁰² are each independently an integer of 0 or more and 4 or less, n³⁰¹ Ra³⁰¹'s and n³⁰² Ra³⁰²'s are each independently a C1-C10 alkyl group, a C6-C12 aryl group, or a C1-C6 alkoxy group; and
in formula (A4), n⁴⁰¹ is an integer of 0 or more and 6 or less, n⁴⁰¹ Ra⁴⁰¹'s are each independently a C1-C10 alkyl group, a C6-C12 aryl group, or a C1-C6 alkoxy group.

12. The electrophotographic photoreceptor according to claim 11, wherein the dicarboxylic acid unit (A) includes at least one selected from the group consisting of the dicarboxylic acid unit (A2), the dicarboxylic acid unit (A3), and the dicarboxylic acid unit (A4).

13. The electrophotographic photoreceptor according to claim 8, wherein the diol unit (B) includes at least one selected from the group consisting of a diol unit (B1) represented by formula (B1), a diol unit (B2) represented by formula (B2), a diol unit (B3) represented by formula (B3), a diol unit (B4) represented by formula (B4), a diol unit (B5) represented by formula (B5), a diol unit (B6) represented by formula (B6), a diol unit (B7) represented by formula (B7), and a diol unit (B8) represented by formula (B8): 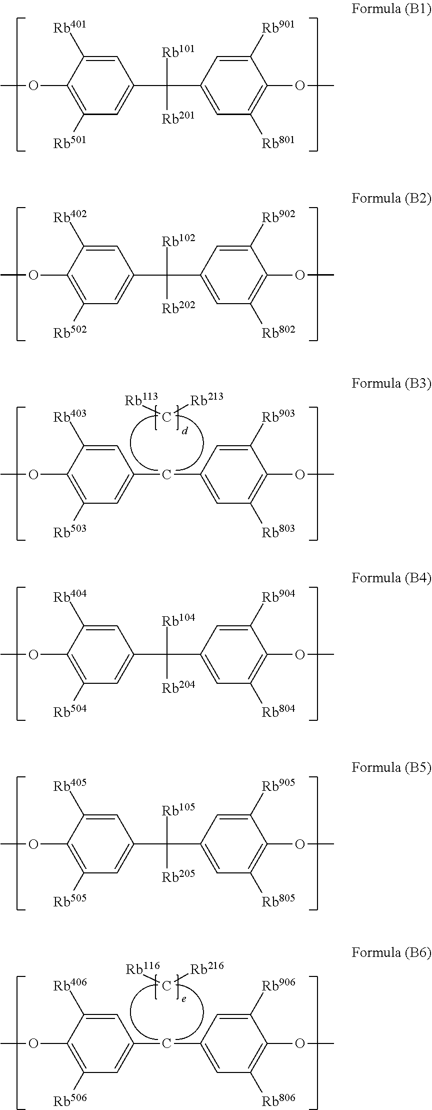 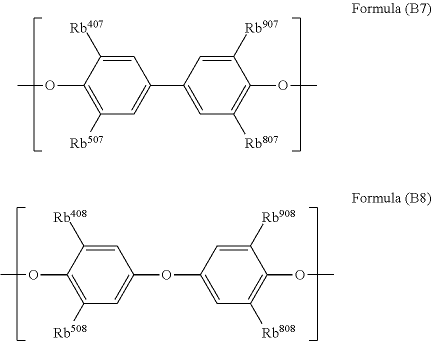
in formula (B1), Rb¹⁰¹ is a C4-C20 branched alkyl group, Rb²⁰¹ is a hydrogen atom or a C1-C3 alkyl group, and Rb⁴⁰¹, Rb⁵⁰¹, Rb⁸⁰¹, and Rb⁹⁰¹ are each independently a hydrogen atom, a C1-C4 alkyl group, a C1-C6 alkoxy group, or a halogen atom;
in formula (B2), Rb¹⁰² is a C4-C20 linear alkyl group, Rb²⁰² is a hydrogen atom or a C1-C3 alkyl group, and Rb⁴⁰², Rb⁵⁰², Rb⁸⁰², and Rb⁹⁰² are each independently a hydrogen atom, a C1-C4 alkyl group, a C1-C6 alkoxy group, or a halogen atom;
in formula (B3), Rb¹¹³ and Rb²¹³ are each independently a hydrogen atom, a C1-C3 linear alkyl group, a C1-C4 alkoxy group, or a halogen atom, d is an integer of 7 or more and 15 or less, and Rb⁴⁰³, Rb⁵⁰³, Rb⁸⁰³, and Rb⁹⁰³ are each independently a hydrogen atom, a C1-C4 alkyl group, a C1-C6 alkoxy group, or a halogen atom;
in formula (B4), Rb¹⁰⁴ and Rb²⁰⁴ are each independently a hydrogen atom or a C1-C3 alkyl group, and Rb⁴⁰⁴, Rb⁵⁰⁴, Rb⁸⁰⁴, and Rb⁹⁰⁴ are each independently a hydrogen atom, a C1-C4 alkyl group, a C1-C6 alkoxy group, or a halogen atom;
in formula (B5), Ar¹⁰⁵ is a C6-C12 aryl group or a C7-C20 aralkyl group, Rb²⁰⁵ is a hydrogen atom or a C1-C3 alkyl group, and Rb⁴⁰⁵, Rb⁵⁰⁵, Rb⁸⁰⁵, and Rb⁹⁰⁵ are each independently a hydrogen atom, a C1-C4 alkyl group, a C1-C6 alkoxy group, or a halogen atom;
in formula (B6), Rb¹¹⁶ and Rb²¹⁶ are each independently a hydrogen atom, a C1-C3 linear alkyl group, a C1-C4 alkoxy group, or a halogen atom, e is an integer of 4 or more and 6 or less, and Rb⁴⁰⁶, Rb⁵⁰⁶, Rb⁸⁰⁶, and Rb⁹⁰⁶ are each independently a hydrogen atom, a C1-C4 alkyl group, a C1-C6 alkoxy group, or a halogen atom;
in formula (B7), Rb⁴⁰⁷, Rb⁵⁰⁷, Rb⁸⁰⁷, and Rb⁹⁰⁷ are each independently a hydrogen atom, a C1-C4 alkyl group, a C1-C6 alkoxy group, or a halogen atom; and
in formula (B8), Rb⁴⁰⁸, Rb⁵⁰⁸, Rb⁸⁰⁸, and Rb⁹⁰⁸ are each independently a hydrogen atom, a C1-C4 alkyl group, a C1-C6 alkoxy group, or a halogen atom.

14. The electrophotographic photoreceptor according to claim 13, wherein the diol unit (B) includes at least one selected from the group consisting of the diol unit (B1), the diol unit (B2), the diol unit (B5), and the diol unit (B6).

15. A process cartridge comprising the electrophotographic photoreceptor according to claim 1,
wherein the process cartridge is attachable to and detachable from an image forming apparatus.

16. A process cartridge comprising the electrophotographic photoreceptor according to claim 2,
wherein the process cartridge is attachable to and detachable from an image forming apparatus.

17. A process cartridge comprising the electrophotographic photoreceptor according to claim 3,
wherein the process cartridge is attachable to and detachable from an image forming apparatus.

18. A process cartridge comprising the electrophotographic photoreceptor according to claim 4,
wherein the process cartridge is attachable to and detachable from an image forming apparatus.

19. A process cartridge comprising the electrophotographic photoreceptor according to claim 5,
wherein the process cartridge is attachable to and detachable from an image forming apparatus.

20. An image forming apparatus comprising:
the electrophotographic photoreceptor according to claim 1;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.
